(19) United States
(12) Patent Application Publication
(10) Pub. No.: US 2005/0084122 A1
(43) Pub. Date: Apr. 21, 2005

(54) Method for constructing a parametric transducer having an emitter film

(75) Inventors: Mark Norris, Poway, CA (US); Norbert Daberko, Encinitas, CA (US); James J. Croft III, San Diego, CA (US)

Correspondence Address: Vaughn W. North;THORPE NORTH & WESTERN, LLP, P.O. Box 1219, Sandy, UT, 84091-1219, US

(73) Assignee: American Technology Corporation

(21) Appl. No.: 10/923,288

(22) Filed: Aug. 20, 2004

Related U.S. Application Data
(63) Continuation-in-part of application No. 09/787,972, filed on Jan. 17, 2002.
(63) Continuation-in-part of application No. 09/159,449, filed on Sep. 24, 1998, now Pat. No. 5,988,116.
(63) Continuation-in-part of application No. 09/478,114, filed on Jan. 4, 2000.
(60) Provisional application No. 60/496,835, filed on Aug. 21, 2003.

(51) Int. Cl. H04B 3/00; H04R 25/00

(52) U.S. Cl. 381/190; 381/77

(57) ABSTRACT

A method for constructing a parametric transducer. The method includes preparing a support member having opposing front and back surfaces, the support member extending along an x-axis and a y-axis. The support member is structured to retain an array of parallel ridges extending along the x-axis and spaced apart along the y-axis at predetermined separation distances. The ridges have forward, film contacting faces to support an emitter film in a desired film configuration for emitting parametric output. An electrically sensitive and mechanically responsive (ESMR) film is applied to the support member with one side of the ESMR film being captured at the film contacting faces, and with arcuate sections disposed between the parallel ridges. The film contacting faces mechanically isolate each of the arcuate sections of ESMR film from adjacent arcuate sections.

Priority of application Ser. No. 60/496,385 filed Aug. 21, 2003 in the U.S. Patent Office is hereby claimed.

Prior Application

This application is a continuation-in-part of Ser. No. 09/787,972 filed Jan. 17, 2002, and of Ser. No. 09/159,442 filed Sep. 24, 1998, and of Ser. No. 09/478,114 filed Jan. 4, 2000. The above disclosures are hereby incorporated herein by reference. The parametric transducer apparatus corresponding to the present invention is disclosed in co-pending application entitled “Parametric Transducer Having An Emitter Film”

### BACKGROUND OF THE INVENTION

1. Field of the Invention

The present invention relates generally to the field of emitter films as used in loudspeakers. More particularly, the present invention relates to the use of a piezoelectric film as an emitter on an ultrasonic parametric transducer.

2. Related Art

Audio reproduction has long been considered a well-developed technology. Over the decades, sound reproduction devices have moved from a mechanical needle on a tube or vinyl disk, to analog and digital reproduction over laser and many other forms of electronic media. Advanced computers and software now allow complex programming of signal processing and manipulation of synthesized sounds to create new dimensions of listening experience, including applications within movie and home theater systems. Computer generated audio is reaching new heights, creating sounds that are no longer limited to reality, but extend into the creative realms of imagination.

Nevertheless, the actual reproduction of sound at the interface of electro-mechanical speakers with the air has remained substantially the same in principle for almost one hundred years. Such speaker technology is clearly dominated by dynamic speakers, which constitute more than 90 percent of commercial speakers in use today. Indeed, the general class of audio reproduction devices referred to as dynamic speakers began with the simple combination of a magnet, voice coil and cone, driven by an electronic signal. The magnet and voice coil convert the variable voltage of the signal to mechanical displacement, representing a first stage within the dynamic speaker as a conventional multistage transducer. The attached cone provides a second stage of impedance matching between the electrical transducer and air envelope surrounding the transducer, enabling transmission of small vibrations of the voice coil to emerge as expansive compression waves that can fill an auditorium. Such multistage systems comprise the current fundamental approach to reproduction of sound, particularly at high energy levels.

A lesser category of speakers, referred to generally as film or diaphragmatic transducers, relies on movement of an emitter surface area of film that is typically generated by electrostatic or planar magnetic driver members. Although electrostatic speakers have been an integral part of the audio community for many decades, their popularity has been quite limited. Typically, such film emitters are known to be low-power output devices having applications appropriate only to small rooms or confined spaces. With a few exceptions, commercial film transducers have found primary acceptance as tweeters and other high frequency devices in which the width of the film emitter is equal to or less than the propagated wavelength of sound. Attempts to apply larger film devices have resulted in poor matching of resonant frequencies of the emitter with sound output, as well as a myriad of mechanical control problems such as maintenance of uniform spacing from the stator or driver, uniform application of electromotive fields, phase matching, frequency equalization, etc.

As with many well-developed technologies, advances in the state of the art of sound reproduction have generally been limited to minor enhancements and improvements within the basic fields of dynamic and electrostatic systems. Indeed, substantially all of these improvements operate within the same fundamental principles that have formed the basics of well-known audio reproduction. These include the concept that (i) sound is generated at a speaker face, (ii) based on reciprocating movement of a transducer (iii) at frequencies that directly stimulate the air into the desired audio vibrations. From this basic concept stems the myriad of speaker solutions addressing innumerable problems relating to the challenge of optimizing the transfer of energy from a dense speaker mass to the almost massless air medium that must propagate the sound.

A second fundamental principle common to prior art dynamic and electrostatic transducers is the fact that sound reproduction is based on a linear mode of operation. In other words, the physics of conventional sound generation rely on mathematics that conform to linear relationships between absorbed energy and the resulting wave propagation in the air medium. Such characteristics enable predictable processing of audio signals, with an expectation that a given energy input applied to a circuit or signal will yield a corresponding, proportional output when propagated as a sound wave from the transducer.

In such conventional systems, maintaining the air medium in a linear mode is extremely important. If the air is driven excessively into a nonlinear state, severe distortion occurs and the audio system is essentially unacceptable. This nonlinearity occurs when the air molecules adjacent the dynamic speaker cone or emitter diaphragm surface are driven to excessive energy levels that exceed the ability of the air molecules to respond in a corresponding manner to speaker movement. In simple terms, when the air molecules are unable to match the movement of the speaker so that the speaker is loading the air with more energy than the air can dissipate in a linear mode, then a nonlinear response occurs, leading to severe distortion and speaker inoperability. Conventional sound systems are therefore built to avoid this limitation, ensuring that the speaker transducer operates strictly within a linear range.

Parametric sound systems, however, represent an anomaly in audio sound generation. Instead of operating within the conventional linear mode, parametric sound can only be generated when the air medium is driven into a nonlinear state. Within this unique realm of operation, audio sound is not propagated from the speaker or transducer element. Instead, the transducer is used to propagate carrier waves of high-energy, ultrasonic bandwidth beyond human hearing. The ultrasonic wave therefore functions as the carrier wave, which can be modulated with audio input that develops sideband characteristics capable of decoupling in air when driven to the nonlinear condition. In this manner, it is the air molecules and not the speaker transducer that will generate the audio component of a parametric system. Specifically, it is the sideband component of the ultrasonic carrier wave that energizes the air molecule with audio signal, enabling eventual wave propagation at audio frequencies.

Another fundamental distinction of a parametric speaker system from that of conventional audio is that high-energy transducers as characterized in prior art audio systems do not appear to provide the necessary energy required for effective parametric speaker operation. For example, the dominant dynamic speaker category of conventional audio systems is well known for its high-energy output. Clearly, the capability of a cone/magnet transducer to transfer high-energy levels to surrounding air is evident from the fact that virtually all high-power audio speaker systems currently in use rely on dynamic speaker devices. In contrast, low output devices such as electrostatic and other diaphragm transducers are virtually unacceptable for high-power requirements. As an obvious example, consider the outdoor audio systems that service large concerts at stadiums and other outdoor venues. Normally, massive dynamic speakers are necessary to develop direct audio to such audiences. To suggest that a low-power film diaphragm might be applied in this setting would be considered foolish and impractical.

Yet in parametric sound production, the present inventors have surprisingly discovered that a film emitter will outperform a dynamic speaker in developing high-power, parametric audio output. Indeed, it has been the general experience of the present inventors that efforts to apply conventional audio practices to parametric devices will typically yield unsatisfactory results. This has been demonstrated in attempts to obtain high sound pressure levels, as well as minimal distortion, using conventional audio techniques. It may well be that this prior art tendency of applying conventional audio design to construction of parametric sound systems has frustrated and delayed the successful realization of commercial parametric sound. This is evidenced by the fact that prior art patents on parametric sound systems have utilized high-energy, multistage-like bimorph transducers comparable to conventional dynamic speakers. Despite widespread, international studies in this area, none of these parametric speakers were able to perform in an acceptable manner.

In summary, whereas conventional audio systems rely on well accepted acoustic principles of (i) generating audio waves at the face of the speaker transducer, (ii) based on a high-energy output device such as a dynamic speaker, (iii) while operating in a linear mode, the present inventors have discovered that just the opposite design criteria are preferred for parametric applications. Specifically, effective parametric sound is effectively generated using (i) a comparatively low-energy film diaphragm, (ii) in a nonlinear mode, (iii) to propagate an ultrasonic carrier wave with a modulated sideband component that is decoupled in air (iv) at extended distances from the face of the transducer. In view of these distinctions, it is not surprising that much of the conventional wisdom developed over decades of research in conventional audio technology is simply inapplicable to problems associated with the generation parametric sound.

One specific area of transducer design that illustrates the uniqueness of parametric emitter design compared to conventional audio transducers is the adaptation of a film emitter to generate ultrasonic output at sufficient energy levels to drive air at the required nonlinear condition. As indicated above, film emitters are known to be low-energy devices. Nevertheless, film emitters have now been developed for parametric transducers as disclosed in the parent patent applications. Such emitter design has generally been characterized as an array of small emitter sections disposed across a monolithic film diaphragm. The following disclosure provides further enhancements to the development of and method of constructing an effective film emitter capable of generating high-power output, despite the traditional view that film emitters were limited to low-power applications.

In particular, the following disclosure reveals new insights in various problems that previous designers have encountered when emitting a compression wave from an emitter film that has been captured to a support member. The following disclosure also provides a method for preparing the film and capturing the film to the support member such that the above problems of previous emitter films are substantially avoided. Finally, a device is disclosed as a means for preparing the film to be captured to a support member.

### SUMMARY OF THE INVENTION

It has been determined that it would be advantageous to develop a parametric speaker system, which uses a piezoelectric film as an emitter, where the film may operate in a substantially relaxed state, having minimal tension or stretching.

The invention provides a method for constructing a parametric transducer, which includes preparing a support member having opposing front and back surfaces, the support member extending along an x-axis and a y-axis. The support member is structured to retain an array of parallel ridge locations extending along the x-axis and spaced apart along the y-axis at predetermined separation distances. The ridge locations have forward, film contacting faces to support an emitter film in a desired film configuration for emitting parametric output. An electrically sensitive and mechanically responsive (ESMR) film is disposed over the support member with one side of the ESMR film being captured at the film contacting faces, and with arcuate sections aligned with and positioned between the parallel ridges. The film contacting faces mechanically isolate each of the arcuate sections of ESMR film from adjacent arcuate sections.

The invention also provides a method for preparing an electrically sensitive and mechanically responsive (ESMR) emitter film for a parametric transducer, which includes heating the ESMR film to a predefined temperature, thereby altering the dimensions of the film in at least one direction. The formed ESMR film is then captured at a support member while the film is in its heated state, thereby maintaining captured portions of the film at their altered dimensions when the film is subsequently cooled, and allowing free-moving portions of the film to return to approximately their original state when the film is subsequently cooled. The method may also include forming the ESMR film to a predetermined configuration while the film is in its heated state, prior to capturing the ESMR film to the support member.

The invention also provides a device for preforming an electrically sensitive and mechanically responsive (ESMR) film to be disposed over a support member of a transducer. The device includes a forming plate having opposing front and back surfaces, the forming plate having an array of parallel arcuate surfaces with respect to the front surface. The arcuate surfaces are separated by an array of parallel ridges. A plurality of apertures provides for airflow through the forming plate at the front surface. A vacuum source is attached to the apertures for creating negative pressure at the front surface.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a flow chart illustrating a method for constructing a parametric transducer, in accordance with an embodiment of the present invention;

FIG. 2 is a perspective bottom view of a support member, in accordance with the method of FIG. 1;

FIG. 3a is a perspective view of an ultrasonic, parametric transducer, including a support member and a piezoelectric type film to be applied to the support member, in accordance with the method of FIG. 1;

FIG. 3b is a perspective view of the transducer of FIG. a, wherein the film has been applied to the support member;

FIG. 3c is a drawing of one embodiment of the support member;

FIG. 4 is a perspective view of a transducer, including a support member having channel cross sections configured with a concave curvature, in accordance with an embodiment of the present invention;

FIG. 5 is a perspective view of a transducer, wherein the film contacting faces of the support member include a convex curvature with respect to the front surface, in accordance with an embodiment of the present invention;

FIG. 6a is a perspective view of a transducer, wherein the film is configured in the form of alternating concave and convex arcuate sections, in accordance with an embodiment of the present invention;

FIG. 6b is a perspective view of a transducer, wherein the film is configured with arcuate sections protruding away from the support member;

FIG. 7a is a flow chart illustrating a method for constructing another parametric transducer, in accordance with an embodiment of the present invention;

FIG. 7b is a perspective view of a transducer, wherein the support member has a front face surface in a smooth continuous configuration, in accordance with the method of FIG. 7a;

FIG. 8 is an enlarged perspective view of a channel cross section, to illustrate some of the critical dimensions of the transducers;

FIG. 9a is a perspective view of a transducer, wherein the support member configures the film to have a concave dish curvature for focusing a propagated wave;

FIG. 9b is a perspective view of a transducer, wherein the support member configures the film to have a convex dish curvature for dispersing a propagated wave;

FIG. 10a is a representation of multiple electrically isolated conductive portions of film being driven by multiple parametric signals created by providing a passive delay line;

FIG. 10b is a representation of a transducer having multiple electrically isolated conductive portions of film in a progressively larger ring configuration;

FIG. 10c is a representation of one method for connecting electrical contacts to the transducer in FIG. 10b;

FIG. 10d is a representation of one method for connecting electrical contacts to the transducer in FIG. 10b;

FIG. 11 is a cross-sectional view of a parametric speaker, wherein the film is coupled to the support member with a C-channel conductive mechanism;

FIG. 12 is a flow chart illustrating a general method for constructing a parametric transducer, in accordance with an embodiment of the present invention;

FIG. 13 is a flow chart illustrating a method for preparing an emitter film for a parametric transducer, in accordance with an embodiment of the present invention;

FIG. 14a is a perspective view of a forming plate used to preform the film, in accordance with an embodiment of the present invention;

FIG. 14b is a perspective view of a second forming plate used to preform the film, in accordance with an embodiment of the present invention;

FIG. 14c is a perspective view of a third forming plate used to preform the film, in accordance with an embodiment of the present invention; and

FIG. 15 is a flow chart illustrating additional steps to the method of FIG. 1.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

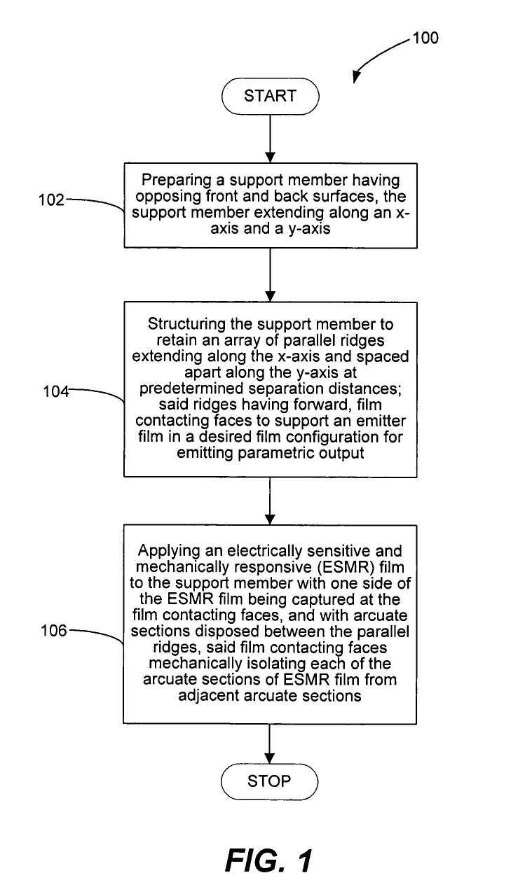

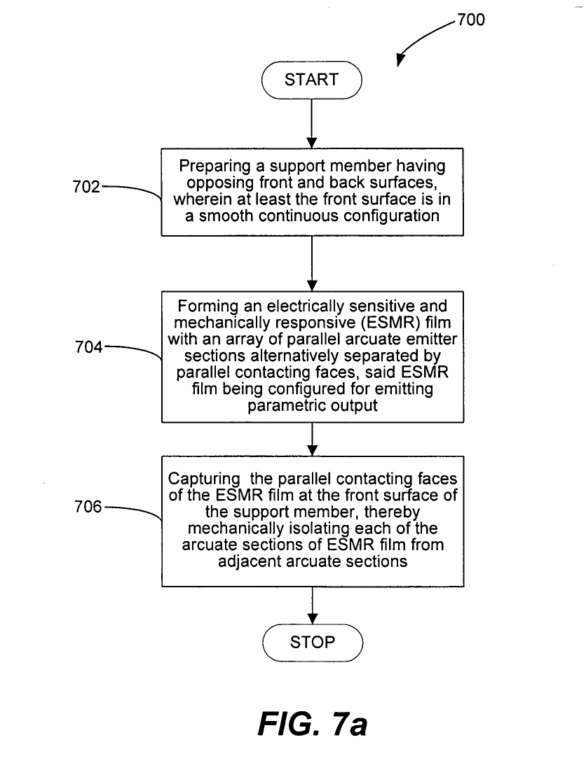

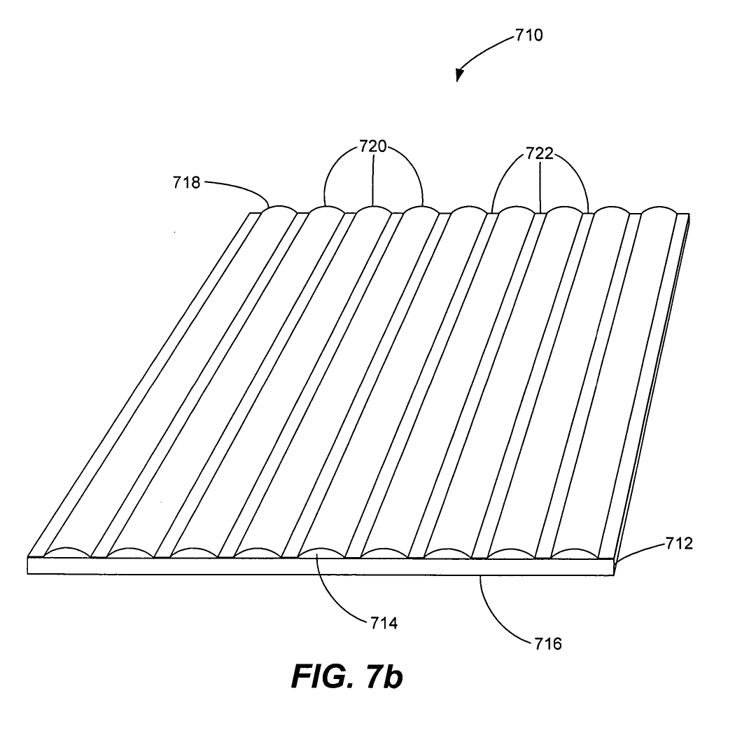

In accordance with FIG. 1, a method 100 is disclosed for constructing one embodiment of a parametric transducer. First, a support member having opposing front and back surfaces is prepared 102, the support member extending along an x-axis and a y-axis. Second, the front surface is structured 104 to retain an array of parallel ridge locations extending along the x-axis and spaced apart along the y-axis at predetermined separation distances. The ridge locations correspond to forward, film contacting faces to support an emitter film in a desired film configuration for emitting parametric output. Third, an ESMR film is applied 106 to the support member with one side of the ESMR film being adhesively or otherwise captured at the film contacting faces, and with arcuate sections disposed between the parallel ridge locations, said film contacting faces mechanically isolating each of the arcuate sections of ESMR film from adjacent arcuate sections. Various embodiments are disclosed herein illustrating support members having flat front surfaces wherein the ridge locations are merely contacting portions for adhering film contacting faces to the support member (see FIG. 7b), as well as other versions that include actual parallel ridges formed as structural components of the support member.

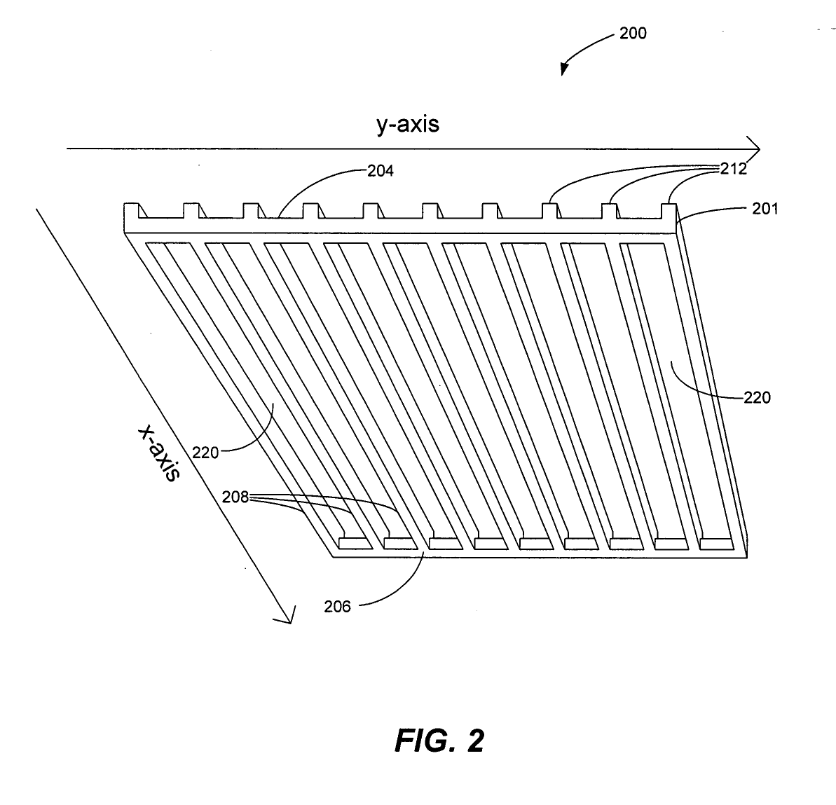

FIG. 2 is a depiction of the prepared support member having parallel ridges 208 as structural components as disclosed in the method of FIG. 1. A bottom view of the support member 201 is shown extending along an x-axis and a y-axis. The support member retains the array of parallel ridges 208 extending along the x-axis and spaced apart along the y-axis at predetermined separation distances. The ridges have forward, film contacting faces 212 to capture the emitter film in the desired film configuration for emitting parametric output. In this embodiment, the sections 220 between the ridges 208 are left open to airflow.

Method 100 may also include forming a backplate on the back surface of the support member, thereby creating an array of parallel channels on the front surface, each channel having a channel cross section and a front face of a predetermined depth and configuration.

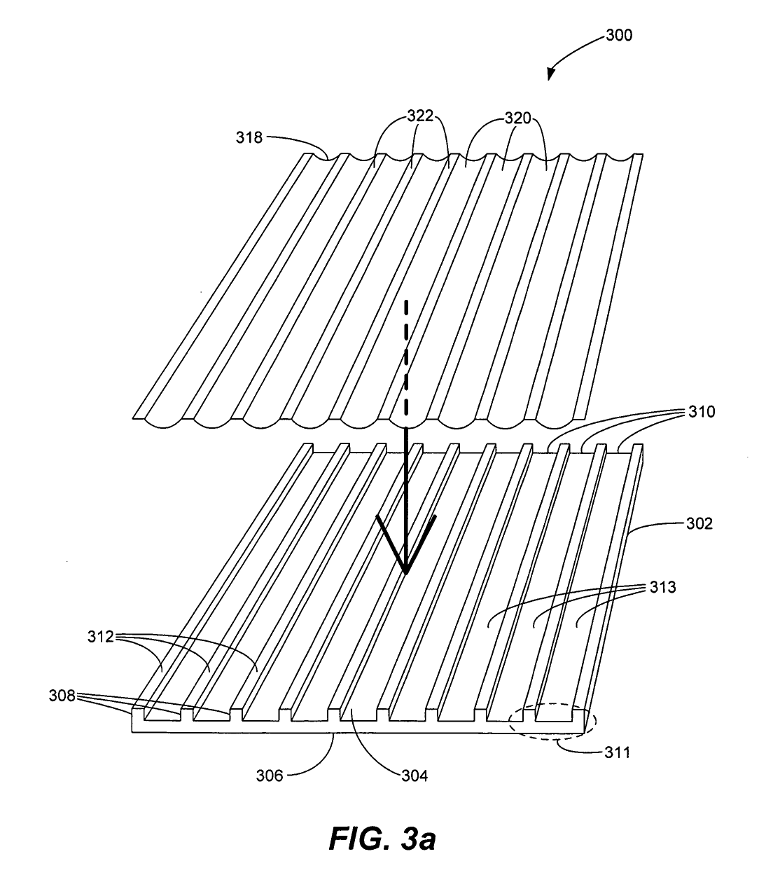

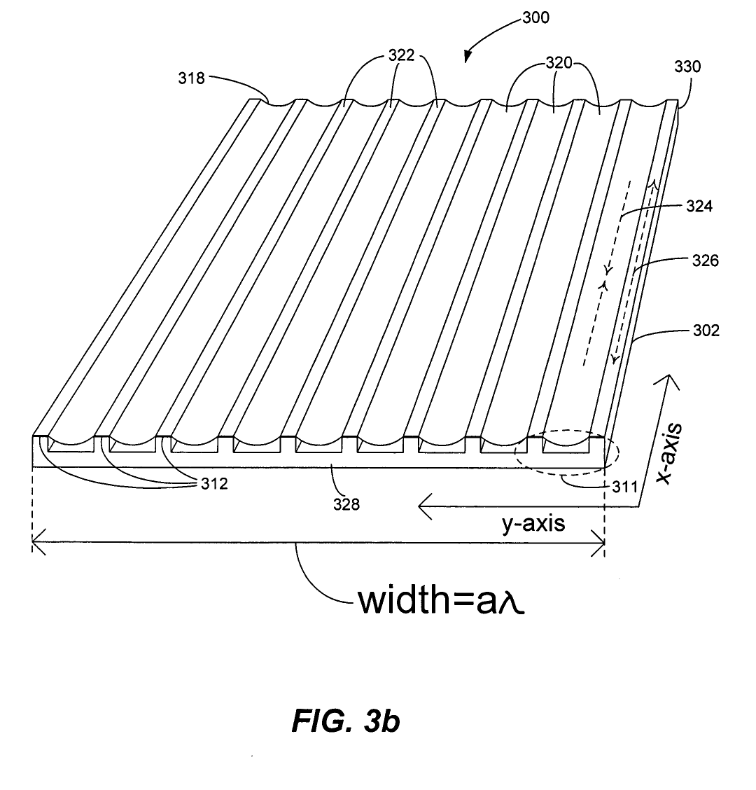

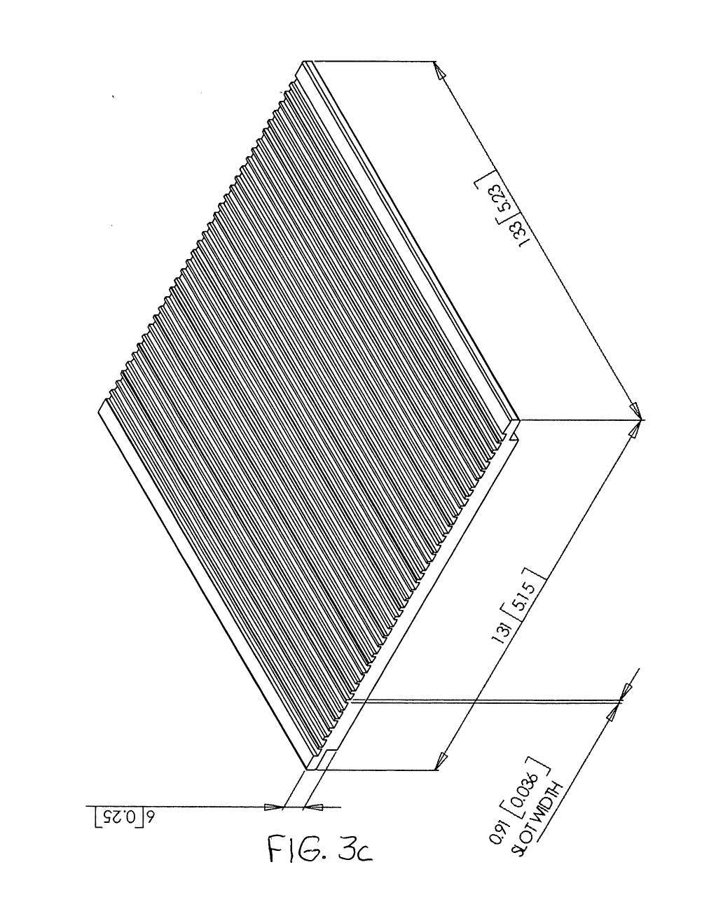

FIG. 3a is a depiction of the transducer disclosed in the method of FIG. 1, having the backplate formed on the back surface. The transducer of FIG. 3 includes the support member 302 having opposing front 304 and back 306 surfaces. The support member extends along an x-axis and a y-axis. The support member retains the array of parallel ridges 308 extending along the x-axis and spaced apart along the y-axis at predetermined separation distances. A backplate has been formed on the back surface 306, creating an array of parallel channels 310 on the front surface, each having a channel cross section 311 and a front face 313 of predetermined depth and configuration. The ridges 308 each have a forward, film contacting face 312 positioned at a height above the support member 302. The film contacting faces 312 are configured to capture a film 318 used as an emitter at a height above the support member 302. The film has arcuate sections 320 aligned with respect to the channel cross sections 311 of the array of parallel channels 310.

Generally, the support member, as applicable to method 100, may consist of any structure that retains the ridges 108 in a substantially parallel configuration. FIG. 1a illustrates a support member having two retaining crossbars extending along the y-axis. More elaborate support members may be used, comprising more or less than two retaining crossbars. An entire backplate, as shown in FIG. 1b, may be used to retain the ridges 108. Numerous variations can be made to the support member shown in FIG. 1a without deviating from the scope of the invention.

The parallel ridges of method 100 may consist of any structures that provide film contacting faces 112 for capturing the film and forming intermediate arcuate sections 116 of film. The cross sections 111 and parallel channels 112 created by the parallel ridges need not be rectangular in shape as illustrated in FIG. 2a. Numerous modifications may be made to the parallel ridges while still providing film contacting faces as disclosed in the invention.

The film contacting faces of method 100 may consist of any structures that are capable of capturing the film between the arcuate sections 116 of film. The film contacting faces should be configured such that when they capture the film, each intermediate arcuate section of film 116 is substantially isolated from all other arcuate sections.

Various types of film may be used as the emitter film. The important criteria are that the film be capable of (i) deforming into arcuate emitter sections at the cavity locations or displaced spaces from the support member, and (ii) responding to an applied electrical signal to constrict and extend in a manner that reproduces an acoustic output corresponding to the signal content. Although piezoelectric materials are the primary materials that supply these design elements, new polymers are being developed that are technically not piezoelectric in nature. Nevertheless, the polymers are electrically sensitive and mechanically responsive in a manner similar to the traditional piezoelectric compositions. Accordingly, it should be understood that reference to piezoelectric films in this application is intended to extend to any suitable film that is both electrically sensitive and mechanically responsive (ESMR) so that acoustic waves can be realized in the subject transducer.

In accordance with method 100 of FIG. 1, and as illustrated in FIG. 3b, the ESMR film 318 is applied to the support member 302 with one side of the ESMR film being captured at the film contacting faces 312, and with arcuate sections 330 aligned with respect to the channel cross sections 311 of the array of parallel channels 310.

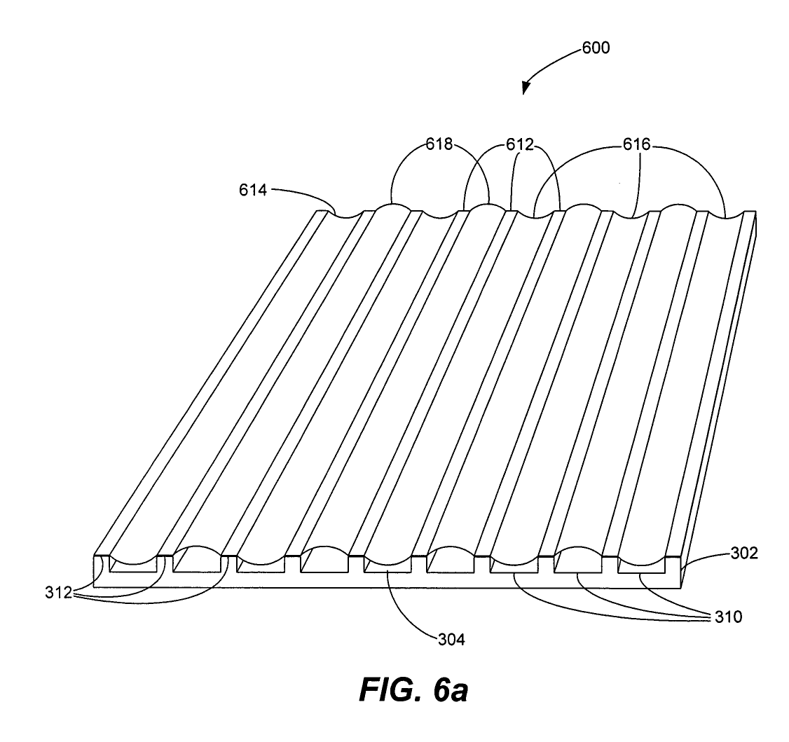

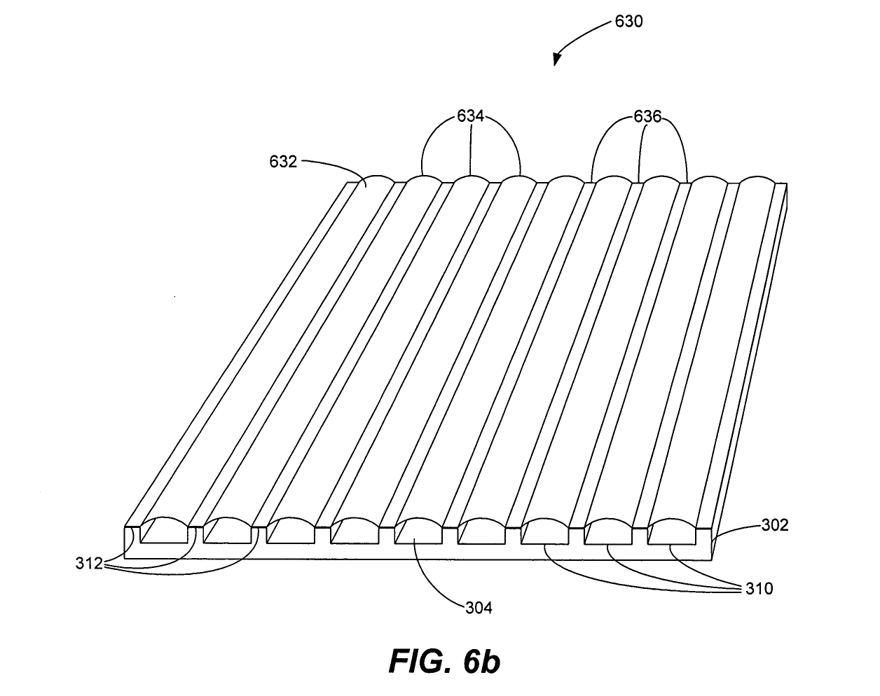

The embodiment shown in FIGS. 3a and 3b comprises the more specific step of applying the arcuate sections in a concave configuration with respect to the front surface 304. The concave configuration creates a transducer that is highly robust in comparison to transducers employing convex arcuate sections (as shown in the embodiment of FIGS. 6b and 7b). Because the arcuate sections are concave, the parallel ridges 308 substantially protect the film from accidental contact during use of the transducer. Another advantage of the concave configuration is that high directionality can be obtained. For example, a convex arcuate section configuration, shown in FIG. 6b, tends to disperse the propagated wave more than the concave configuration.

When the emitter film 318 is applied to the support member 302 of FIG. 3a, where a backplate has been formed on the back surface 306, the support member and the backplate may only allow an emitted wave to propagate in a forward direction. However, when the emitter film 318 is applied to the basic support member 201 in FIG. 2, the back surface has openings 220 allowing airflow between the front 204 and back 206 surfaces. Thus, the support member may allow bidirectional propagation of emitted waves, both in a forward direction and in a rearward direction.

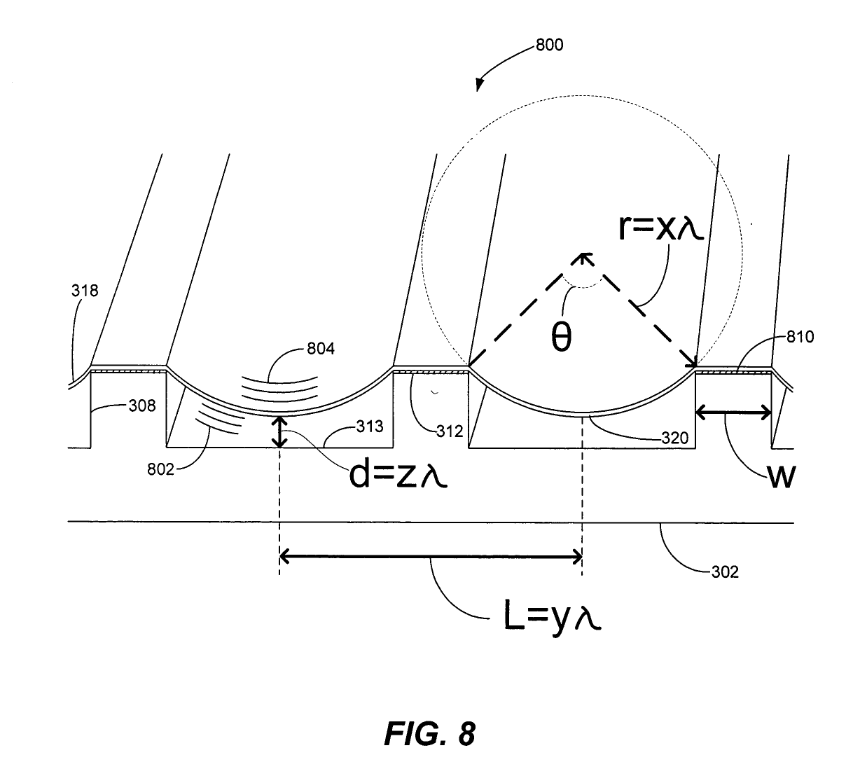

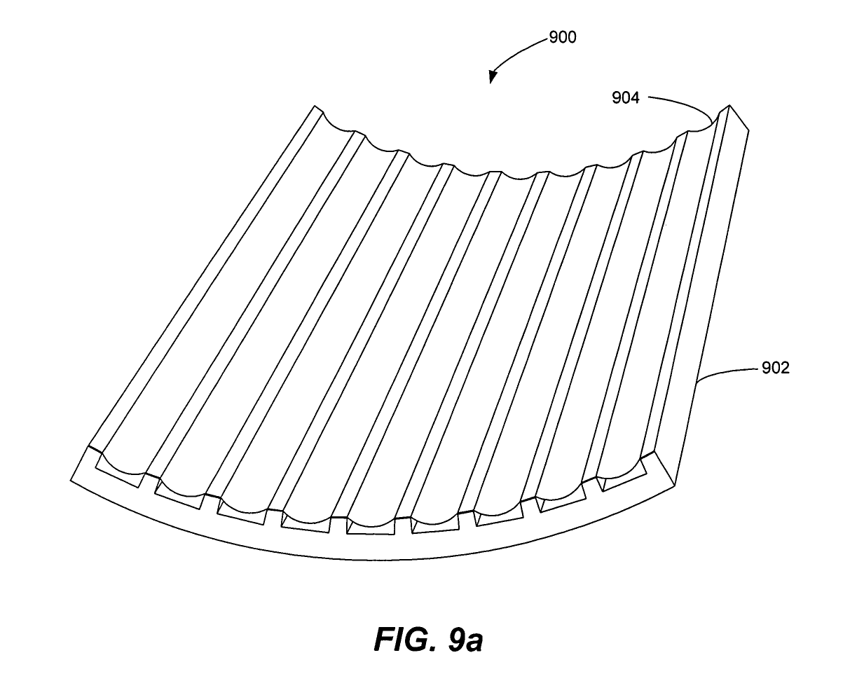

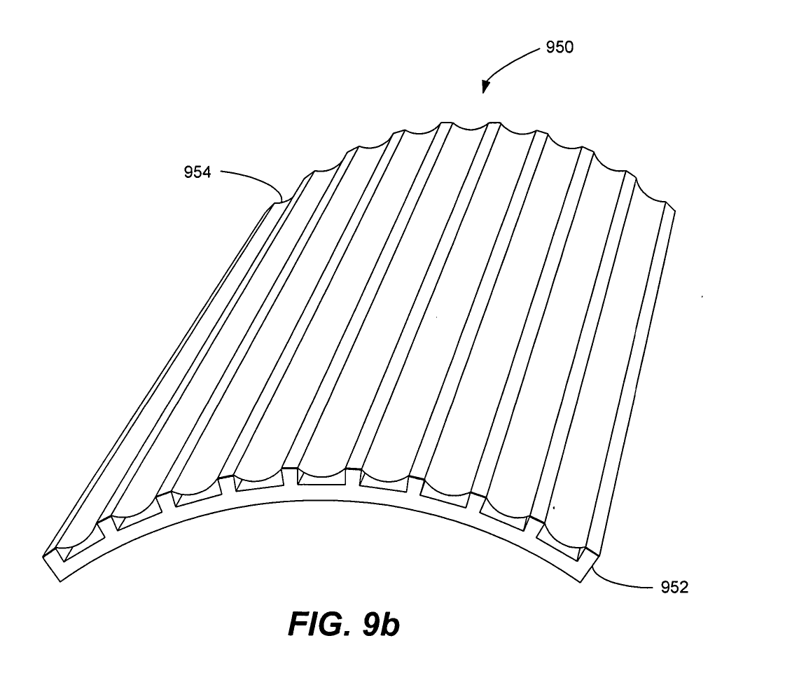

FIG. 3c is a drawing of one embodiment of the support member. The support member has a width along the y-axis of 131 millimeters, or 5.15 inches. The support member has a length along the x-axis of 133 millimeters, or 5.23 inches. The height of the support member is 6 millimeters, or 0.24 inches. The width of each film contacting face, labeled “slot width” in FIG. 9 and ‘w’ in the enlarged view of FIG. 8, is 0.91 millimeters, or 0.036 inches. As illustrated in the above embodiment, the present invention realizes an effective parametric ultrasonic loudspeaker in a very simple, compact device.

[Jim-do you want to add new measurements for current preferred embodiment?]

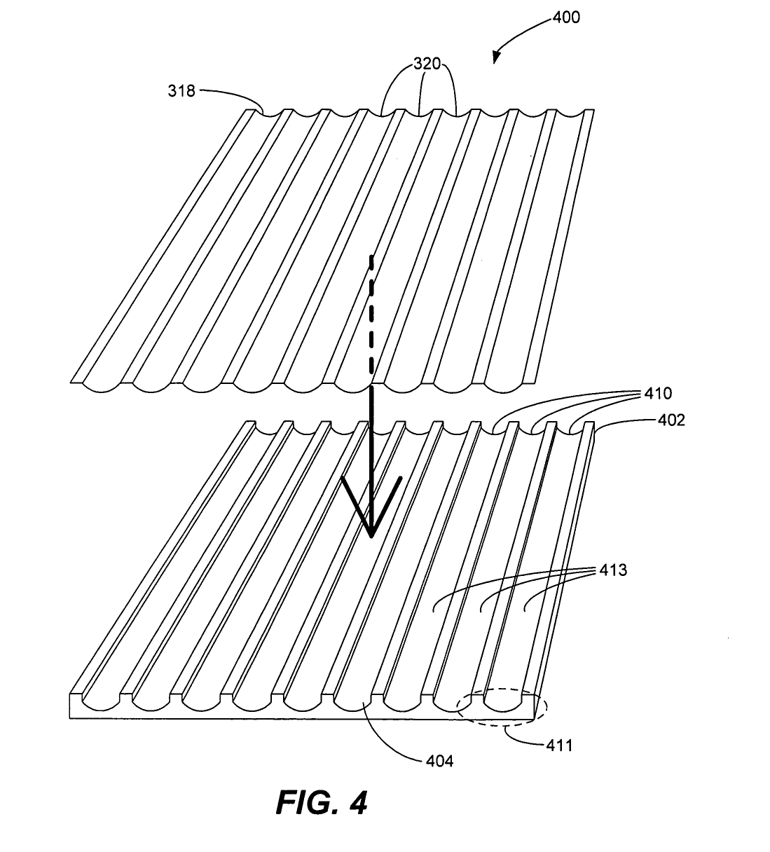

Method 100 may include the more specific step of configuring the channel cross sections with a curvature approximately corresponding to the arcuate sections of the ESMR film extending into the channel cross sections. FIG. 4 portrays the transducer where the channel cross sections 411 have been configured with a curvature approximately corresponding to the arcuate sections 320 of the film 318 extending into the channel cross sections 411. This step enables a more constant distance between the film 318 and the front face 313 of the parallel channels 310. Instead of being flat, as are the parallel channels 310 in FIG. 3a, the parallel channels 410 in FIG. 4 are concave with respect to the front surface 404 of the support member 402. In this configuration, the film 318 may be positioned at a distance of approximately ¼ λ from the front faces 413 of the parallel channels 410 throughout the width of each parallel channel instead of only at a central peak depth of the film's arcuate sections. Refer to FIG. 8 for a more detailed illustration of the distance between the film and the front faces of the parallel channels.

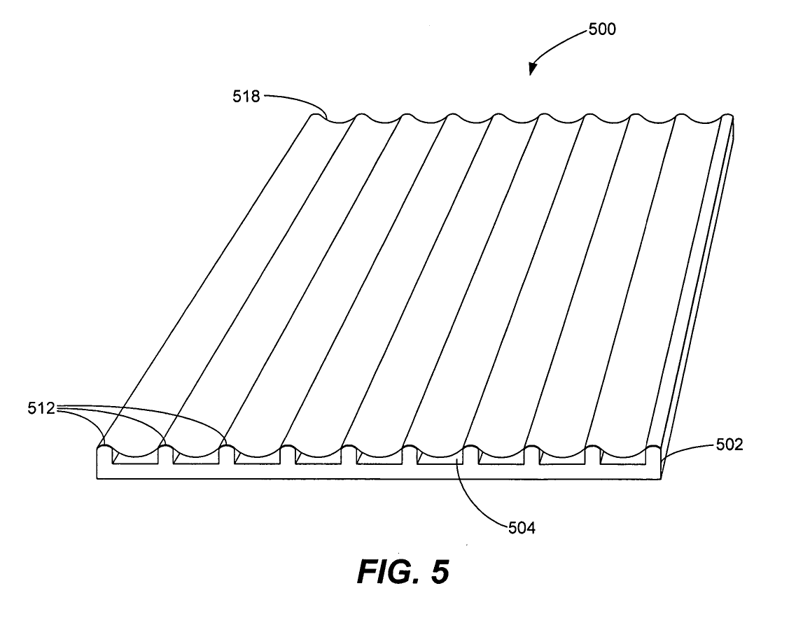

As depicted in FIG. 5, method 100 may further include structuring the film contacting faces 512 to include a convex curvature with respect to the front surface 504 of the support member 502. Consequently, the ESMR film 518 is formed on the support member 502 without any abrupt edges. The smoothness of the film provides a uniform surface wherefrom parametric signals are propagated.

The concepts from FIGS. 4 and 5 may be combined, such that the support member includes parallel channels 410 having a concave curvature with respect to the front surface of the support member and film contacting faces 512 having a convex curvature with respect to the front surface of the support member. Thus, the transducer will have the benefits of maintaining the film at a nearly constant distance from the parallel channels of the support member, and of providing a uniform surface.

As depicted in FIG. 6a, method 100 may also include configuring the ESMR film 614 to alternate between a concave arcuate section 616 and a convex arcuate section 618. The concave and convex arcuate sections are separated by contacting sections 612 corresponding to the film contacting faces 312 of the support member 302. When the contacting sections 612 are captured by the film contacting faces, each arcuate section of film is isolated from adjacent arcuate sections. This embodiment of the invention may help to avoid even-order distortion in the emitted wave. This embodiment is unique over a continuous sine wave shape, without the contacting sections 612 separating the concave 616 and convex 618 arcuate sections. The continuous sine wave shaped film can produce multiple sidelobe waves (waves that propagate in a direction other than the main column of sound). Thus, the high-directionality normally provided by parametric loudspeakers can be substantially lost. When the contacting sections 612 are captured at the film contacting faces 312, the movement of each of the arcuate sections 616 and 618 is isolated. This isolation substantially eliminates the propensity for sidelobes in the propagated wave.

As illustrated in FIG. 6b , the film may be configured such that the arcuate sections 634 of the film 632 extend away from the channel cross sections of the array of parallel channels 310, where the arcuate sections are convex with respect to the front surface 304 of the support member 302. This embodiment may cause the waves propagated from the film 632 to disperse more than the embodiment shown in FIG. 3b , where the arcuate sections extend into the channel cross sections. Because the arcuate sections extend away from the support member 302, the film 632 is prone to accidental bumps during use, causing the film to be susceptible to dents, which impairs the film's ability to generate pure output.

In accordance with FIG. 7a, method 700 is also disclosed for constructing a parametric transducer. First, a support member having opposing front and back surfaces is prepared 702, wherein at least the front surface is in a smooth continuous configuration. Second, an electrically sensitive and mechanically responsive (ESMR) film is formed 704 with an array of parallel arcuate emitter sections alternatively separated by parallel contacting faces, said ESMR film being configured for emitting parametric output. Third, the parallel contacting faces of the ESMR film are captured 706 at the front surface of the support member, thereby mechanically isolating each of the arcuate sections of ESMR film from adjacent arcuate sections.

FIG. 7b is a depiction of the constructed transducer as disclosed in the method 700. The transducer 710 is comprised of the support member 712 having opposing front 714 and back 716 surfaces, wherein at least the front surface 714 is in a smooth continuous configuration, meaning that the support member does not have the ridges as shown in FIG. 3a and 3b. Instead, the support member has parallel ridge locations where the ESMR film is captured (see 722) as described previously. An ESMR film 718 is disposed over the front surface 714 of the support member 712, said ESMR film being configured for emitting parametric output. The ESMR film is also configured with an array of parallel convex arcuate sections 720 alternatively separated by parallel contacting faces 722. The contacting faces are captured at the front surface 714 of the support member 712, thereby mechanically isolating each of the arcuate sections 720 of ESMR film from adjacent arcuate sections.

FIG. 8 is an enlarged perspective view of two cross sections 311 from FIG. 3a. The radius of the film's curvature and the distance between the peaks of the arcuate sections 116 of the film 114 may affect the performance of the transducer. Although the transducer from FIG. 3a (from method 100) is employed here by way of example, the measurements disclosed hereinafter are equally applicable to all embodiments of the present invention, including method 700. The variable ‘r’ represents the radius of the film's curvature, and the variable ‘L’ represents the distance between adjacent central peak depths of the arcuate sections 320 of the film 318. The variable λ represents the wavelength of a carrier wave frequency. The variables x, y and z represent a designated fraction of a wavelength.

The resonance frequency of the film is dependant on ‘r’. As ‘r’ gets smaller, the resonance frequency of the film rises. To optimize the interaction of the parametric waves in the air so that maximum decoupling of the waves occurs, it may be beneficial to position the arcuate sections 320 such that L≦½ λ.

In another embodiment of the invention, the distance ‘L’ and/or the radius ‘r’ may vary throughout the transducer structure. In order to vary the distance ‘L’, the separation distances of the parallel ridges 308 must also vary by the same amount. By varying the distance ‘L’, the radius ‘r’ of the arcuate sections 320 may also be altered. As stated above, altering ‘r’ will affect the resonance frequency of the film. Therefore, varying the radius ‘r’ and/or the distance ‘L’ will create multiple resonance frequencies, which may be desired if a wide frequency spectrum is required.

The distance from the arcuate sections 320 of the film 318 to the front face 313 of the parallel channels may also affect the performance of the transducer. The variable ‘d’ represents the distance from the central peak depth of the film's arcuate sections 320 to the front face 313 of a parallel channel 310. In one embodiment, d≦½ λ. When d=½ λ, the propagated wave that is emitted from the back of the film 802 may reflect off of the support member 302, and return out of phase with the wave emitted from the front of the film 318. Consequently, the extra sound pressure may drive the arcuate sections 320 of the film 318 out of their desired polarity, and may cause destructive interference with the wave emitted from the front of the film 804. In a preferred embodiment, where d≦¼ λ, the interference and cancellation that may occur when d=½ λ is avoided. Therefore, it may be preferred that not only the central peak of the arcuate section of the film be less than ½ λfrom the front face of the parallel channel, but also that the entire length of film be less than ½ λ from the front face of the parallel channel 110.

In a preferred embodiment, the arc lengths of the arcuate sections 320 are defined by a central angle, labeled ‘θ’ in FIG. 8, of 100 degrees or less. This method of limiting the arc length provides numerous advantages over film emitters whose arc length is defined by a central angle of approximately 180 degrees (also described as a rectified sine wave form). The present invention offers lower distortion, a smoother frequency response, and fewer spurious resonant frequencies than the rectified sine form. Furthermore, because the arcuate sections of the present invention are usually smaller than the rectified sine form, the present invention is more robust and reliable.

Once the ESMR film is captured at the support member 302 of FIGS. 3b or 712 of FIG. 7b, an electrical parametric signal may be applied to the film, causing the arcuate sections to vibrate. Because areas of the ESMR film between the arcuate sections are captured at the film contacting faces 312 or at the support member 712 in FIG. 7b, the movement of each arcuate section of film is substantially mechanically isolated. This mechanical isolation of the arcuate sections substantially eliminates the possibility of vibrations from one arcuate section interfering with the vibrations of another arcuate section. The width of the film contacting faces, labeled ‘w’ in FIG. 8, may be strategically established so that the film contacting faces are as small as possible, thus maximizing the area of film that is free to vibrate and maximizing the amplitude of the propagated waves, yet wide enough to mechanically isolate the movement of each arcuate section of film. By mechanically isolating the movement of the arcuate sections 116 of film, the exact curvature and radius (‘r’ in FIG. 8) of each arcuate section can be more precisely set and maintained than could be accomplished if the movement of each section of film were not mechanically isolated. By maintaining precise control over each arcuate section of film, as provided by the mechanical isolation technique of the present invention, the shape of the entire film may be highly uniform. This uniformity results in the film having a Q of at least greater than two, creating an emitted wave that is more than six dB above the reference level of the transducer. It may be preferable that a high degree of uniformity of the film be maintained, resulting in a Q much greater than two.

It may also be preferred that the width of ESMR film emitters of methods 100 and 700, labeled ‘width’ in FIG. 3b, be at least approximately five wavelengths of a carrier wave frequency to be propagated from the transducer. The present inventors have further discovered that these procedures surprisingly enable implementation of larger emitters having dimensions of 10 wave lengths or more, including monolithic film emitters as disclosed herein. Such large dimensions can be in either the x or y direction, or both. For nonparametric applications, the choice of wave lengths would be based on the primary or dominant operating frequencies of the speaker.

As depicted in FIG. 9a, methods 100 and 700 may include configuring the support member 902 and the ESMR film 904 to have a concave dish curvature for focusing a propagated wave. In this embodiment, the wave propagated from the film 904 can be focused at a relatively small area. As a further variation of FIG. 9a, the entire film can be formed as a concave bowl, allowing the propagated wave to be focused at a designated point in space.

As depicted in FIG. 9b, methods 100 and 700 may include configuring the support member 952 and the ESMR film 954 to have a convex dish curvature for dispersing a propagated wave. In this embodiment, the wave propagated from the film 954 can be dispersed over a relatively large area. As a further variation of FIG. 9b, the entire film can be formed as a convex bowl, allowing the propagated wave to be dispersed to an even larger area.

Methods 100 and 700 may further include biasing the ESMR film into the arcuate sections at the film contacting faces without application of negative pressure to the ESMR film at the array of parallel ridges.

As previously mentioned, methods 100 and 700 may include capturing the ESMR film at the film contacting faces using an adhesive substance. The adhesive substance is denoted as 810 in FIG. 3. There may be a preference that the adhesive be electrically conductive, so that the film contacting faces 312 may also serve as electrodes to transfer a voltage applied to the support member to the ESMR film 318. When high levels of voltage are applied to an ESMR film, the film may generate heat that must be dissipated. Hence, there may be a preference that the adhesive be thermally conductive, so that the support member 302 may also serve as a heat sink for the ESMR film 318. Finally, to ease the manufacturing process, and to improve the reliability of the transducer, there also may be a preference that the adhesive have a rapid cure time, facilitated when an accelerating or activating fluid is applied. When the adhesive material is applied to the film contacting faces, it is important to apply the adhesive as uniformly as possible. Inconsistencies in the adhesives or film contacts may result in inconsistencies in the arcuate sections of the film, causing a lower Q, and unwanted distortion. A screen-printing technique may be used to uniformly apply the adhesive. It may be preferred that the thickness of the adhesive be less than ten thousandths of an inch. By proper selection of adhesives to secure the film ridges on the support member, mechanical isolation can be well controlled. For example, Locktite 392 adhesive has demonstrated effective use as a two component bonding system. UV bonding systems may offer even greater control, but would require a clear plastic support member such as polycarbonate material to be used to facilitate light activation of the adhesive. Other bonding systems will be apparent to those skilled in the art and may provide the desired uniform isolation properties.

Methods 100 and 700 may include configuring the parallel channels of support member to have opposing ends that are maintained open to airflow to avoid pressure differentials of varying altitudes and to provide cooling. FIG. 3b exemplifies this configuration, in that the parallel channels 310 are open to airflow. In another embodiment, the parallel channels 310 are configured to have at least one of the opposing ends 318 and 320 that is substantially blocked to airflow.

With the ESMR film and the support member in the configurations disclosed in the present invention, many benefits are acquired over the prior art. First, the use of an ESMR film is superior to the use of an array of hundreds or even thousands of bimorph transducers. An array of bimorph transducers requires separate wiring to drive each bimorph transducer. This adds to the complexity and cost of manufacture. Conversely, the use of an ESMR film may only necessitate one electronic coupling in order to drive the film. Furthermore, when an array of bimorph transducers is used, each transducer will likely be positioned at a slightly different angle, creating undesired phase differentials and a non-uniform wave front. Because ESMR film is a uniform, continuous surface, the waves emitted by the film are also uniform, with very little undesired phase differential.

The use of ESMR film in a substantially non-pressured state also has benefits over the prior art method of using a permanent vacuum to shape the film. A permanent vacuum will apply continuous pressure to form the film into its desired configuration. This continuous stress may stretch the ESMR film and cause the film to have a variable resonance frequency depending on the tension of the film at a particular point, and may cause the emitted waves to contain unwanted distortion. However, capturing the film in a substantially non-pressured state at a support member in accordance with the present invention avoids the use of a permanent vacuum, while maintaining the film in its desired configuration. Because the film is in a substantially non-pressured state, the frequency response of the film is more consistent, and the waves emitted from the film more closely resemble the intended waveform.

Furthermore, use of a permanent vacuum applies pressure on only one side of the film. In this condition, the vibrations of the film tend to expand further in one direction than the other. This effect can generate even-order, or asymmetric distortion in the emitted wave. Even-order distortion causes spurious even harmonics (2^{nd}, 4^{th}, 6^{th}, etc.) to be added to a signal passing through a device. Because the present invention provides a method of maintaining the arcuate sections in the film without the permanent application of a vacuum, the film is free to vibrate equally in both directions, thus substantially eliminating even-order distortion in the emitted wave.

Finally, use of a permanent vacuum requires additional structure for maintenance and the containment of the vacuum. Such a structure adds to the mass, volume, and manufacturing complexity of the speaker. The support member 102 of the present invention is much thinner than the drum or other support member previously used to provide the vacuum chamber in the prior patent application, and is also more durable.

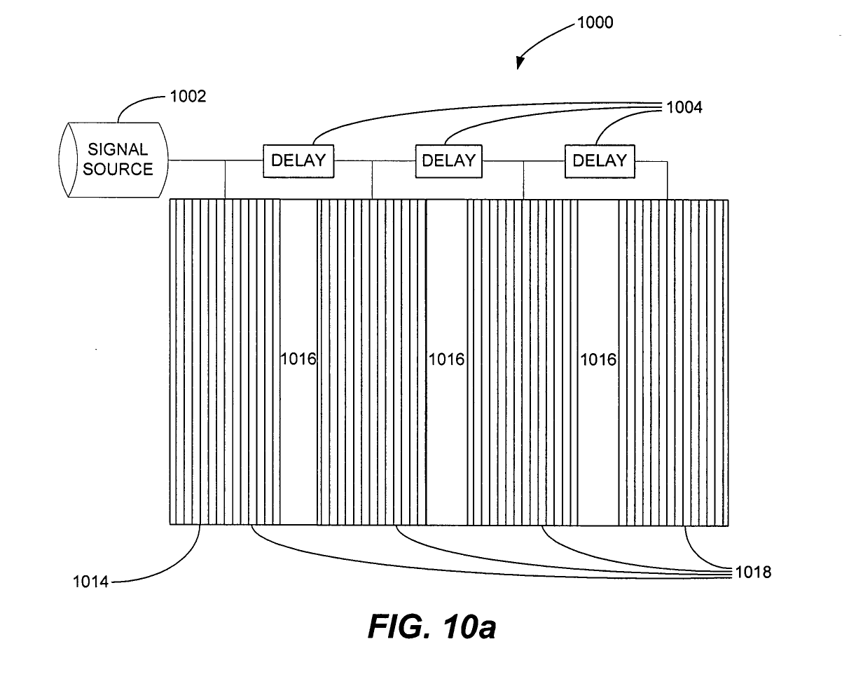

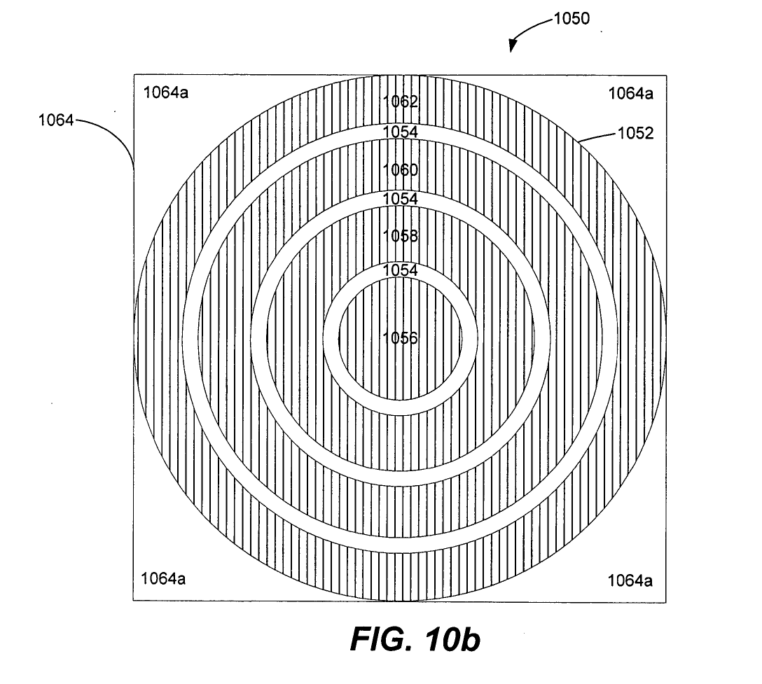

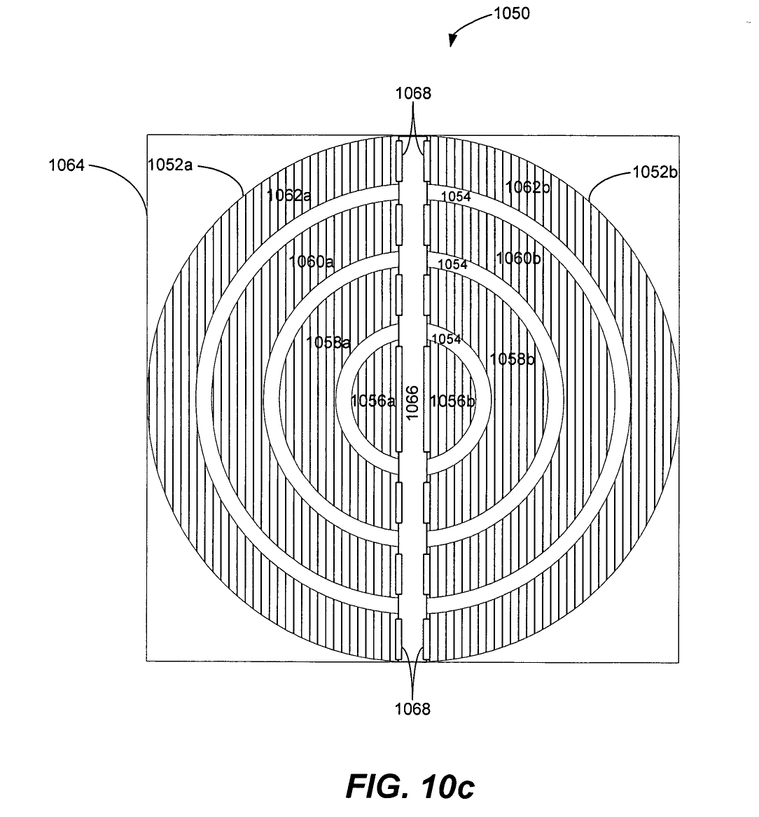

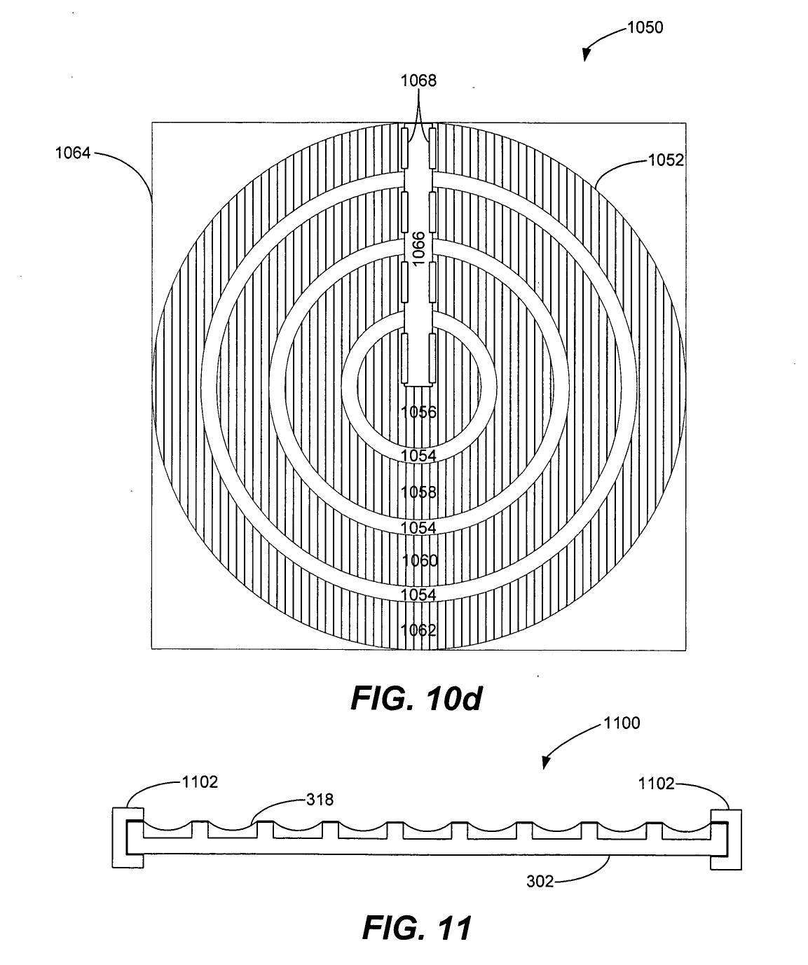

As depicted in FIG. 10a, methods 100 and 700 may include configuring the transducer such that phase controlling of the propagated wave at the emission surface may be performed. The film 1014 is divided into multiple electrically isolated conductive portions 1018 by etching away separating strips 1016. Preferably, only the conductive portion of the separating strips 1016 has been etched away, so that the film emitter 1014 is still one continuous, uniform piece of film. Each of the electrically isolated portions of film may be driven by a unique parametric signal. The unique parametric signal may be produced by a delay line 1004, which is electronically coupled to a signal source 1002. The delay line is comprised of a plurality of delay circuits, wherein each delay circuit is electronically coupled to one of the separate pieces of film. The delay circuits may be either active or passive delays. By phase delaying the parametric signal applied to one piece of film more than the parametric signals applied to other pieces of film, a phase differential between the pieces of film is created, and the sound beam can be guided in different directions by optimizing the phase relationship between the different electrically isolated portions of film to maximum amplitude summation in a predetermined direction or point in space by achieving the minimum phase differential from the film regions in that predetermined direction or point in space. While FIG. 10a only shows a one-by-four array of electrically isolated conductive portions, more complex arrays can be formed that allow precise phase control of the propagated wave at the emission surface, thus allowing for precise directivity of the wave front. The delay circuits may also be switchable so that the delay can be turned off, creating an emitter surface that does not control phase of the propagated wave at the emission surface. Alternatively, instead of delay circuits, the electrically isolated conductive portions of film may be sized and wired in or out of phase in relationships that can minimize the phase differential and maximize the parametric output in the preferred direction.

As illustrated in FIG. 10b, the method depicted in FIG. 10a may be altered such that at least one ring section 1054 of the electrically conductive portion of the ESMR film is etched away on at least a front or a back side surface, or both sides. The etching forms at least a center circular conductive portion of film 1056, and at least one outer ring portion of conductive film 1058, 1060, and 1062. Each conductive portion of film 1056, 1058, 1060, and 1062 is electrically isolated. The etched ring portions of film 1054 are formed as thin as possible while avoiding electrical arcing between the conductive portions of film 1056, 1058, 1060, and 1062. The thickness of the etched portions may be one-sixteenth of an inch. The phases of the isolated conductive portions 1056 and 1060 may be set to zero degrees, and the phases of the parametric signals driving the isolated conductive portions 1058 and 1062 may be shifted by 180 degrees. Thus, the sound beam propagated from the film can be manipulated to converge to a specific point in space.

It has also been discovered that techniques applied to generation of printed circuit boards may be used to develop a support member useful with the present monolithic film emitter. For example, the support member may be formed by etching or other known procedures for preparing a printed circuit board. The structure of the support member would conform to the design parameters set forth herein. This is particularly suitable for use with the illustrated embodiments in FIGS. 10a and 10b. The conductive sectors of the film would be configured to match the conductive portions of the printed circuit support member and could be implemented with a common mask to insure identity of corresponding sectors. The versatility of the present invention is reflected in the fact that many compositions of material may be applied to the support member, such as conventional PCB substrates, polycarbonate, and related materials.

In another embodiment of FIG. 10b, the conductive portions 1058, 1060, and 1062 may be sized and phased such that their propagated waves will arrive at a designated point in space preferably within a ±90 degree phase change and for a an even more efficient result a ±45 degree phase differential at the designated point in space or less may be employed. The central conductive portion 1056 may be sized such that its propagated wave will arrive at the same designated point in space within a ±90 degree phase change. The diameters of each conductive ring portion of film will depend on the carrier wave frequency and the distance of the desired focal point from a front surface of the transducer.

While FIG. 10b shows only four conductive portions of film, the film may be divided into any number of conductive portions. The delay circuits used to create the phase differentials may be switchable so that the delay can be turned off, creating an emitter surface that does not modify the phase of the propagated wave at the emission surface.

The ESMR film 1052 may be placed on any support member 1064, including but not limited to the support members disclosed in the present invention. Because the support members disclosed in the invention may be square or rectangular in shape, the corners of the support member 1064a may not conform to the ring configuration of the conductive portions of film. Therefore, the corners 1064a may be left bare (without film) as shown in FIG. 10b. Alternatively, the conductive ring portions of film may extend throughout the corners, but will not be continuous through the side portions of the support member. Extending the conductive ring portions throughout the corners of the support member provides a greater film surface area, thereby generating propagated waves with increased amplitudes.

Various techniques of creating electrical contacts to the conductive portions of film may be employed. One technique, illustrated in FIG. 10c is to divide the entire piece of film in half, separating the film into two pieces 1052a and 1052b. By separating the film, electrical contacts 1068 can be placed on the inner edges of the conductive portions of film. The electrical contacts 1068 may be secured in place by a thin circuit board 1066 extending the entire diameter of the ESMR film. The circuit board 1066 may also contain the delay line discussed previously, and supply the electronic signals to the electronic contacts 1068.

Another technique of creating electrical contacts to the conductive portions of film, illustrated in FIG. 10d, is to slice away one section of film. Electrical contacts 1068 can then be placed on the inner edges of the conductive portions of film. The electrical contacts 1068 may be secured in place by a thin circuit board 1066 extending through the portion of ESMR film that has been sliced away. The circuit board 1066 may also contain the delay line discussed previously, and supply the electronic signals to the electronic contacts 1068 or may merely be a routing means to connect a desired amplifier output polarity or phase to each ring.

An example of a focusing parametric transducer as described in FIGS. 7b, 7c, and 7d will now be provided. This example transducer is designed to create a focal point at 36 inches from the front surface of the transducer, using a carrier frequency of 46 kHz. The ESMR film is mounted on a 14″ square support member. The conductive ring portions each have a radius of 2.3″ (inner circle), 4″, 5.16″, 6.1″, 6.9″, and 7.68″ (extending into the corners of the support member, and being cut off on the edges). To achieve maximum output and focus at the 36 inch distance the rings are phased such that the center portion as section one and each odd numbered section/ring are at zero phase reference and each even ordered section/ring is operated 180 degrees out of phase compared to the zero phase reference. This may be made to be switch-able such that all section/rings can operate in-phase forming a normal parametric column.

As depicted in FIG. 11, the methods 100 and 700 may also include coupling the ESMR film to edges of the support member 302 using a C-channel conductive mechanism 1102. The C-channel may be composed of a conductive material, and provides a relatively large electrical coupling area between the C-channel and the ESMR film 318 as compared to point contacts of electrical coupling.

In addition to electronically coupling the edges of the film to the signal source using the C-channels, the film may be electronically coupled to the signal source in various positions throughout the center of the film. When using large pieces of ESMR film, and when coupling the signal source to the edges of the film, the resistive losses of the film's metallization may attenuate the signal near the center of the film. By electronically coupling the film to the signal source in various positions throughout the center of the film, the signal strength remains substantially consistent throughout the film. One method of electronically coupling the center of the film to the signal source is by applying the signal source to one or more conductive film contacting faces, which are electronically coupled to the corresponding captured portions of film.

In the above cases, the separate conductive regions of the film diaphragm may be isolated on both the front and back surface sides of the film or may be only isolated from each other on one surface side, with the remaining surface side of the film being conductively continuous across that surface side. In the later case, the continuous side may be driven from a common ground potential of an amplifier system with alternate polarity, phases or delays driving the isolated regions on the opposite surface side.

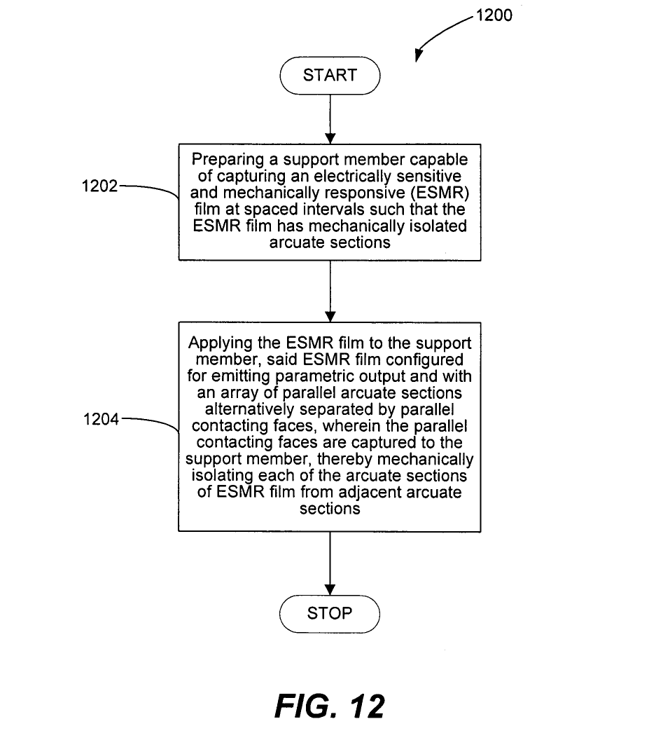

In accordance with FIG. 12, a method 1200 is also disclosed for constructing a parametric transducer. First, a support member is prepared 1202 that is capable of capturing an electrically sensitive and mechanically responsive (ESMR) film at spaced intervals such that the ESMR film has mechanically isolated arcuate sections. Second, the ESMR film is applied 1204 to the support member, said ESMR film configured for emitting parametric output and with an array of parallel arcuate sections alternatively separated by parallel contacting faces, wherein the parallel contacting faces are captured to the support member, thereby mechanically isolating each of the arcuate sections of ESMR film from adjacent arcuate sections.

In the above methods, and in various parent applications, the inventors have disclosed transducers employing a piezoelectric film emitter captured to a support member, such that captured portions of the film are fixed in one position. The inventors have now discovered that when an electronic audio signal is applied to an emitter film to produce an audio compression wave, the electronic current passing through the resistive losses of the film's metallization may cause the temperature of the film to rise by a significant amount. As the temperature of the emitter film rises, the film expands and/or contracts in at least one dimension by up to approximately 2%. While the free-moving portions of film will expand and/or contract, the captured portions of film are fixed, creating tension between the free-moving portions and the captured portions of film. This tension creates buckling and folds in the free-moving portions of the film. Consequently, the amplitude of the propagated wave decreases, and distortion is created.

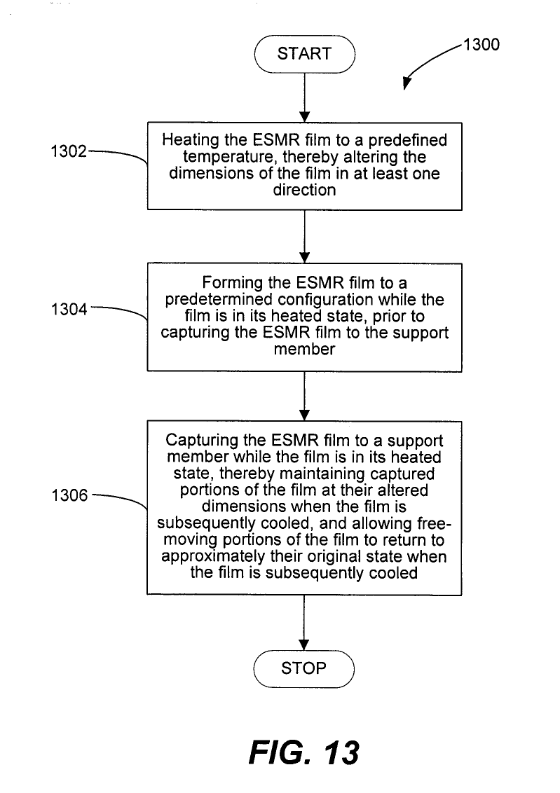

To resolve the tension occurring in the free-moving portions as described above, a method 1300, in FIG. 13, is disclosed for preparing an ESMR emitter film to be applied to a transducer membrane. Method 1300 may include heating 1302 the ESMR film to a predefined temperature, thereby altering the dimensions of the film in at least one direction. Method 1300 may further include capturing 1306 the ESMR film to a support member while the film is in its heated state, thereby maintaining captured portions of the film at their altered dimensions when the film is subsequently cooled, and allowing free-moving portions of the film to return to approximately their original state when the film is subsequently cooled. In addition to the above steps, and as illustrated in FIG. 13, method 1300 may further include forming 1304 the ESMR film to a predetermined configuration while the film is in its heated state, prior to capturing the ESMR film to the support member.

By heating 1302 the film prior to forming 1304 the film or applying 1306 the film to the support member, the film dimensions will expand and/or contract to approximately the same dimensions the film will assume during operation, when a voltage is applied causing the temperature of the film to rise. When the heated film is captured 1306 to the support member, the film may subsequently be cooled to an ambient temperature. The cooled film attempts to contract to approximately its original size, but the captured portions are forced to remain in their expanded form. When the film is subsequently driven by an electronic signal during operation, the film's temperature rises, causing the free-moving portions of film to expand and/or contract yet again. Because the entire film will then have assumed the expanded form, the film will operate in a substantially untensioned state, with minimal unwanted buckling or folding in the film. Consequently, the amplitude of the propagated wave will be maximized, with minimal distortion.

Method 1300 focuses on all ESMR emitter films that are or will be captured at a “support member.” Various support members are provided herein by way of example. However, the method 1300 is equally applicable to all ESMR films that are to be captured at a support member and that generate heat during operation. The defining characteristic of a “support member”, as applied to method 1300, is any device capable of retaining an emitter film in a predefined configuration.

The defining characteristic of a film being “captured” at a support member, as applied to method 1300, is that the film be fixed in at least one dimension to at least one point of the support member. To be captured, the captured portions of film should not be able to slide substantially or adjust substantially when lateral pressure is exerted to the film. All films that are captured to a support member, as defined herein, fall within the scope of method 1300.

The inventors have found method 1300 to be particularly helpful when preparing an ESMR film for use in parametric ultrasonic transducers. Parametric ultrasonic transducers commonly require high levels of power in order to drive the surrounding air into nonlinearity, as is required for acoustic heterodyning. Consequently, the temperature of the film rises considerably, causing significant expanding and/or contracting of the film.

While method 1300 is useful in the field of parametric ultrasonic speakers, the method has other applications as well. These applications include preparing an ESMR film for use in conventional speaker transducers (not using parametric technology), and preparing an ESMR film for use in microphone-type transducers, or other types of sensors.

The heating performed on the film in method 1300 should not be confused with thermal forming. In thermal forming, the film is heated to such a high temperature that the film will permanently retain its molded configuration when the heat is removed. In method 1300, the heat is chosen such that the heat causes the film to expand, but does not necessarily cause the film to retain a new shape. If the film were not captured at the support member, the entire film would be free to contract to approximately its pre-expanded shape when subsequently cooled. However, because the film is captured at the support member while heated, which alters the film's dimensions, the captured portions of the film are forced to retain their expanded and/or contracted states even when cooled, while the free-moving portions of film may contract to their approximate pre-expanded shapes.

The ideal temperature to produce this result may be the approximate temperature reached by the film while it is being driven by an electronic parametric ultrasonic signal. The ideal temperature may be the approximate temperature reached by the film while it is being driven by a conventional electronic audio signal. The temperature may be approximately 50 degrees Celsius. Even when the above temperatures are used, there is a possibility that minor thermal forming may still occur, because minor thermal forming is unavoidable whenever certain types of film are heated to any degree. However, because minor thermal forming may be unavoidable, it is preferable that the thermal forming occur prior to capturing the film to the support member. Otherwise, a similar amount of thermal forming would occur after capturing the film to the support member, because similar temperatures are produced during operation. When minor thermal forming occurs during operation, the results are largely uncontrollable, and may be less than desirable. Thus, the unavoidable minor thermal forming that may occur during heating 1302 prior to capturing the film 1306 minimizes any potential thermal forming that would have occurred after capturing the film to the support member had the film not been preheated.

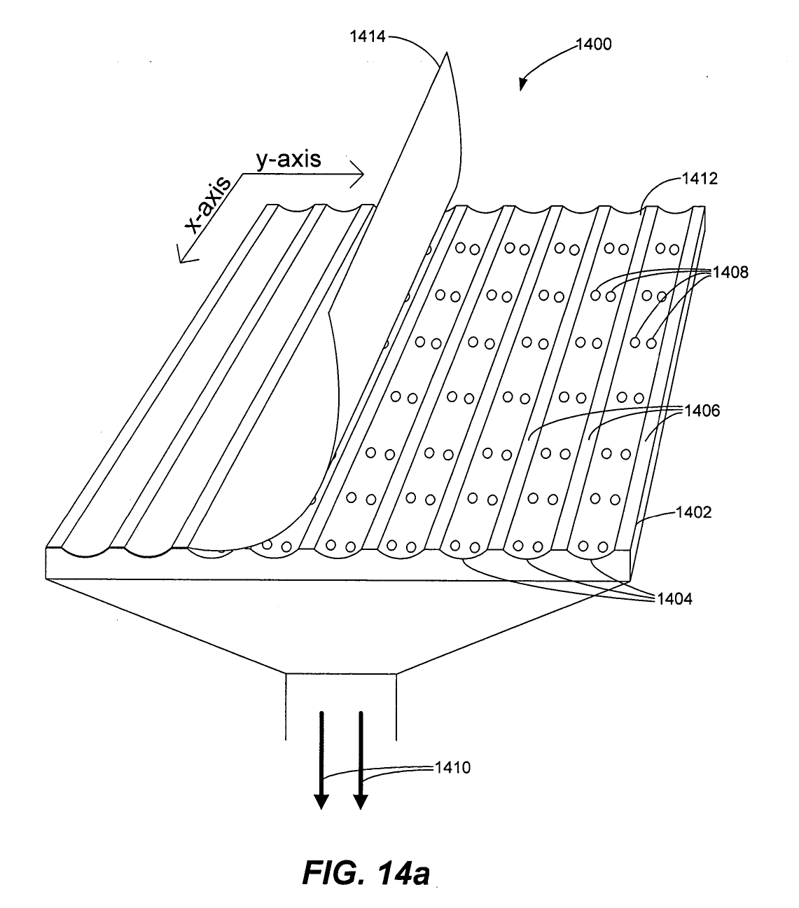

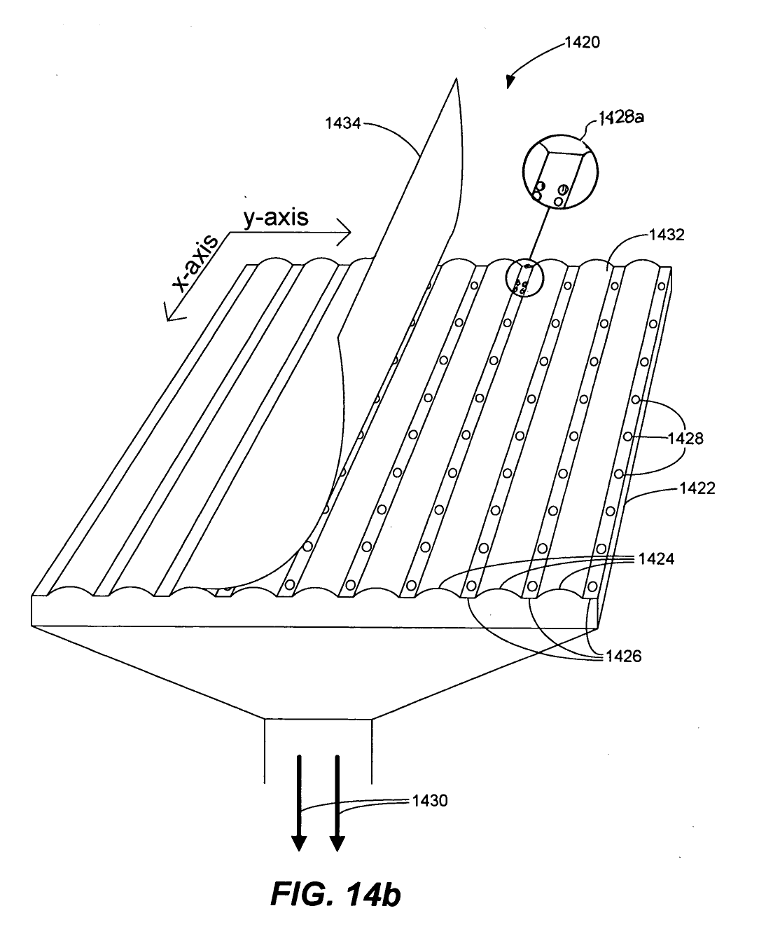

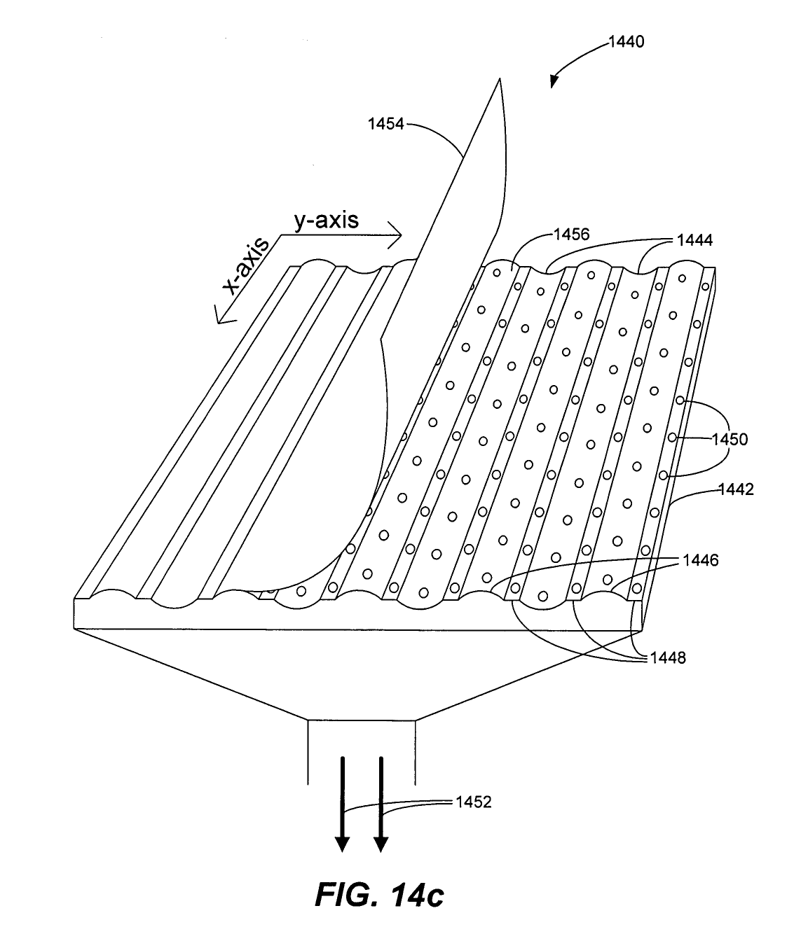

A device as shown in FIGS. 14a, 14b, and 14c is also disclosed for preforming an electrically sensitive and mechanically responsive (ESMR) film to be disposed over a support member of a transducer. In general, the device is comprised of a forming plate having opposing front and back surfaces. The forming plate has an array of parallel arcuate surfaces with respect to the front surface. The device also includes an array of parallel ridges separating the arcuate surfaces. These ridges may project forward of the arcuate surfaces as shown in FIG. 14a, or may be recessed rearward as shown in FIG. 14b. The device also includes a plurality of apertures providing for airflow through the forming plant at the front surface. The device also may include a vacuum source attached to the apertures for creating negative pressure at the front surface.

Specifically, the device 1400 shown in FIG. 14a may be used to preform the ESMR film into its designated shape. A forming plate 1402 having opposing front 1412 and back (hidden) surfaces and having an array of parallel, concave arcuate surfaces 1404 separated by upright ridges 1406 is provided as a mandrel or mold for shaping the film 1414. Small apertures 1408 are provided in the forming plate 1402 creating a means for airflow to the front surface 1412 of the forming plate 1402. A vacuum source 1410 is attached to the apertures 1408 for creating negative pressure at the front surface 1412. A film 1414 may be rolled onto the forming plate 1402 such that the film is sequentially preformed in each successive channel 1404 without applying any undue tension or stretching to the film along the y-axis. Once the film 1414 has been preformed to the shape of the forming plate 1402, it may be captured at a support member, completing the basic transducer structure. In the embodiment shown in FIG. 14a, each of the inverted ridges 1406 is flat, so as to preform the film in the configuration shown in FIG. 6b or 7b. In another embodiment, each of the inverted ridges 1406 is convex with respect to the front surface 1412 of the forming plate, so as to preform the film into a smoother configuration.

FIG. 14b illustrates an alternate device 1420 that may be used to preform the ESMR film into its designated shape. A forming plate 1422 having opposing front 1432 and back (hidden) surfaces and having an array of parallel, convex arcuate surfaces 1424 separated by inverted ridges 1426 is provided as a mandrel or mold for shaping the film 1434. Small apertures 1428 are provided in the forming plate 1422 creating a means for airflow to the front surface 1432 of the forming plate 1422. A vacuum source 1430 is attached to the apertures 1428 for creating negative pressure at the front surface 1432. A film 1434 may be rolled onto the forming plate 1422 such that the film is sequentially preformed in each successive channel 1424 without applying any undue tension or stretching to the film along the y-axis. Once the film 1434 has been preformed to the shape of the forming plate, it may be captured at a support member, completing the basic transducer structure. In the embodiment shown in FIG. 4, each of the inverted ridges 1426 is flat, so as to preform the film in the configuration shown in FIG. 3b. Additional vacuum openings can be applied along the edges of the curvature 1424 to facilitate complete displacement of the film into these indented junctures between the channel forming structures 1424 and the ridges 1426. Other vacuum hole configurations will be apparent to those skilled in the art. See for example the variation in hole configuration in the enlarged, circled portion of the drawing of FIG. 14b, wherein multiple openings are positioned at the edges of the curved channel forming structures. In another embodiment, each of the inverted ridges 1426 is concave with respect to the front surface 1432 of the forming plate, so as to preform the film in the smoother configuration shown in FIG. 5.

FIG. 14c illustrates an alternative device 1440 that may be used to preform an ESMR film to be disposed over a support member. Particularly, the device 1440 may form the film to the configuration shown in FIG. 6a . A forming plate 1442 having opposing front 1456 and back (hidden) surfaces and having an array parallel of alternating concave 1444 and convex 1446 arcuate surfaces separated by ridges 1448 is provided as a mandrel or mold for shaping the film 1454. Small apertures 1450 are provided in the forming plate 1442 creating a means for airflow to the front surface 1456 of the forming plate. A vacuum source 1452 is attached to the apertures 1450 for creating negative pressure at the front surface 1456. A film 1454 may be rolled onto the forming plate 1442 such that successive channels of the film are preformed without applying any undue tension or stretching to the film along the y-axis. Once the film 514 has been preformed to the shape of the forming plate, it may be captured at a support member, completing the basic transducer structure 600 shown in FIG. 6a .

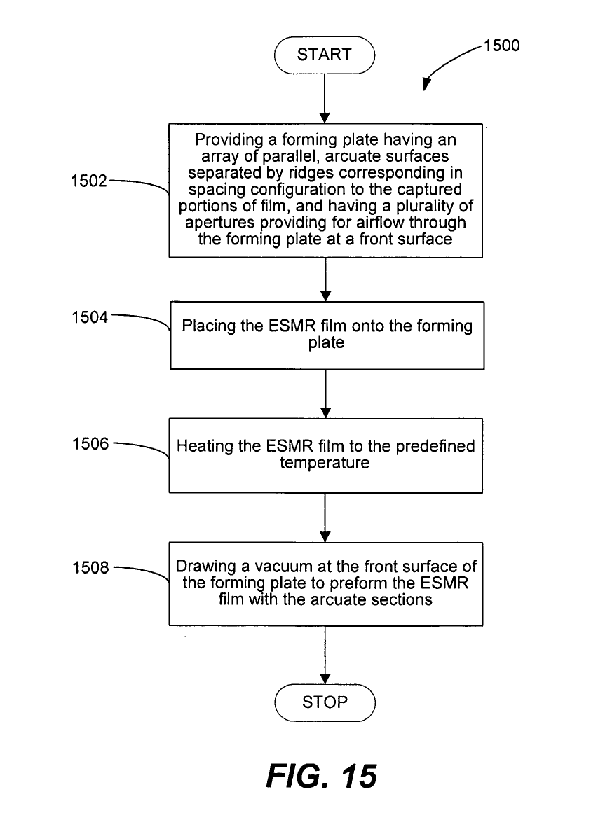

As illustrated in FIG. 15, method 1300 may also include using one of the devices shown in FIGS. 14a, 14b, or 14c to preform the film. The additional steps 1500 may include providing 1502 a forming plate having an array of parallel, arcuate surfaces separated by ridges corresponding in spacing configuration to the captured portions of the film, and having a plurality of apertures providing for airflow through the forming plate at a front surface. The film may be placed 1504 onto the front surface of the forming plate. The film may be heated 1506 to a predefined temperature. This may be accomplished by heating the forming plate either before or after placing the film on the forming plate. A vacuum may be drawn 1508 at the front surface of the forming plate to preform the film with the arcuate sections. To ensure a uniform array of curved channels across the face of the film, it is useful to activate a vacuum conditioin at the openings 1408, 1428 and 1450 in a sequential manner. This is accomplished by applying vacuum suction at adjacent channels of the forming plate in a sequential manner. As illustrated, one or more of the channels at one side of the forming plate might be activated with the vacuum condition deform the film into these channels as shown in figures. This pattern of forming the channel structure in the film is applied progressively across the film face, enabling each channel structure to fully and uniformly seat at the surface of the forming plate. It should be noted that this same process could commence along other portions of the forming plate, such as in a central region of the plate. In this case, the film could be sequentially and concurrently advanced in opposite directions across the face of the forming plate.

Method 1300 may also include forming the support member to have an array of parallel ridges separated from one another in a spacing configuration corresponding to the captured portions of the film. The ridges have forward, film contacting faces to capture the ESMR film in a desired film configuration. FIGS. 2, 3a, and 3b are examples of this type of support member.

As illustrated in FIG. 3a and 3b, a preferred configuration of the film as disclosed in method 1300 may include an array of arcuate sections 320 running parallel to each other, said arcuate sections separated from one another in spacing configuration corresponding to the captured portions 322 of the film 318.

By way of example, the transducer of FIG. 3b may be constructed using the method 1300. The transducer FIG. 3b is an exceptional emitter for producing parametric output. If method 1300 were used to prepare the film 318, the film would be heated to a predefined temperature prior to capturing the film to the support member 302, thereby expanding the film along the y-axis and contracting the film along the x-axis. The film would be formed into the preferred configuration, having the array of arcuate section 320, prior to capturing the film to the support member. Forming the film into the array of arcuate sections may be performed using the forming device shown in FIG. 14b. Finally, the film would be captured to the support member while in its heated state, yielding the transducer 300.

Because the film 318 is captured at the support member 302 while in its heated state, being expanded along the y-axis, the captured portions of the film are maintained in their expanded states when the film is subsequently cooled. Therefore, the captured portions are stretched in an outward direction, as indicated by the arrows 326. The free-moving portions of film are allowed to return to approximately their original state when the film is subsequently cooled, as indicated by the arrows 324. However, when an electronic signal is applied to the film during operation, the film temperature rises, causing the free-moving film portions 320 to expand. Because the entire film 318 will have assumed the expanded form, the film will operate in a substantially relaxed, untensioned state, with no undesired buckling or folds in the film. Consequently, the amplitude of the propagated wave will be maximized, with minimal distortion.

Method 1300 may also include the step of forming the support member having opposing front and back surfaces, wherein at least the front surface is in a smooth continuous configuration. An ESMR film is disposed over the front surface of the support member, said ESMR film being configured for emitting parametric output. The ESMR film is also configured with an array of parallel convex arcuate sections alternatively separated by parallel captured portions. FIG. 7b is an example of this type of support member.

Method 1300 may also include adhering the formed film to the support member by applying a thin, uniform layer of adhesive to the film contacting faces of the support member, and capturing the film contacting faces of the support member to the back surface of the ESMR film while the ESMR film is in its heated, expanded state, such that captured portions of the ESMR film at the film contacting faces are fixed in their expanded state, and the arcuate sections are free to contract into their original state at ambient temperature.

As discussed above, the forming devices of FIGS. 14a and 14b have ridges 1406 and 1426. The ridges 1406 of FIG. 14a may be configured to have a convex curvature with respect to the front surface 1412 of the forming plate. The ridges 1426 of FIG. 14b may be configured to have a concave curvature with respect to the front surface 1432 of the forming plate. This may be done for the purpose of forming a film without any abrupt edges, as illustrated in FIG. 5. Once the film is appropriately formed on the forming plate, the film can be positioned on the support plate with adhesive applied to capture the flat ridge portion of the film on the flat ridge portion of the support plate as shown. The forming plate serves as a useful mandrel manipulating the formed film into the correct position for capture directly onto the support plate.

The method 1300 and the devices of FIGS. 14a, 14b, and 14c may also be utilized to perform the film to the concave dish configuration of FIG. 9a or the convex dish configuration of FIG. 9b.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. For example, an array of parallel, cylindrical fingers or rods forming a grid could serve as a forming surface to apply the desired curvature for the channel structure of the film. The intermediate, suspended film between the rods could then be directly captured at the flat ridges of the support member by means of vacuum openings on the face of the flat ridges. Once the film is secured to these ridges, the rods could be pulled free from the film, leaving the curved channels in an operable mode. Accordingly, it will be apparent to those of ordinary skill in the art that numerous modifications can be made without departing from the principles and concepts of the invention as set forth in the claims.

1. A method for constructing a parametric transducer, comprising the steps of:
(a) preparing a support member having opposing front and back surfaces, the support member extending along an x-axis and a y-axis;
(b) structuring the support member to retain an array of parallel ridge locations extending along the x-axis and spaced apart along the y-axis at predetermined separation distances; said ridge locations having forward, film contacting faces to support an emitter film in a desired film configuration for emitting parametric output; and
(c) applying an electrically sensitive and mechanically responsive (ESMR) film to the support member with one side of the ESMR film being captured at the film contacting faces, and with arcuate sections disposed between the parallel ridge locations, said film contacting faces mechanically isolating each of the arcuate sections of ESMR film from adjacent arcuate sections.

2. A method as defined in example 1, comprising the more specific step of applying the ESMR film with the arcuate sections in a concave configuration with respect to the front surface and the parallel ridge locations comprising parallel ridges extending extending forward of the arcuate sections.

3. A method as defined in example 1, comprising the more specific step of applying the ESMR film with the arcuate sections in a convex configuration with respect to the front surface.

4. A method as defined in example 1, further comprising the step of forming a backplate on the back surface of the support member, thereby creating an array of parallel channels on the front surface, each channel having a channel cross section and a front face of a predetermined depth and configuration.

5. A method as defined in example 4, comprising the more specific step of configuring the channel cross sections with a curvature approximately corresponding to the arcuate sections of the ESMR film extending into the channel cross sections.

6. A method as defined in example 5, comprising the more specific step of establishing the height of the film contacting faces such that the arcuate sections of the ESMR film each have a separation distance from the front face of the parallel channels of no greater than approximately one-quarter wavelength of a carrier wave frequency to be propagated from the transducer.

7. A method as defined in example 4, comprising the more specific step of establishing the height of the film contacting faces such that the arcuate sections of the ESMR film each have a separation distance from the front face of the parallel channels of less than approximately one-half wavelength of a carrier wave frequency to be propagated from the transducer.

8. A method as defined in example 7, comprising the more specific step of establishing the height of the film contacting faces such that the arcuate sections of the ESMR film each have a separation distance from the front face of the parallel channels of no greater than approximately one-quarter wavelength of the carrier wave frequency to be propagated from the transducer.

9. A method as defined in example 7, comprising the more specific step of establishing the height of the film contacting faces such that at least central peak depths of the arcuate sections of the ESMR film each have a separation distance from the front face of the parallel channels of no greater than approximately one-quarter wavelength of the carrier wave frequency to be propagated from the transducer.

10. A method as defined in example 1, further comprising the step of biasing the ESMR film into the arcuate sections at the film contacting faces without application of negative pressure to the ESMR film at the array of parallel ridges.

11. A method as defined in example 1, further comprising the step of maintaining open airflow along opposing ends of the array of parallel ridges.

12. A method as defined in example 1, further comprising the step of substantially blocking airflow from at least one opposing end of the array of parallel ridges.

13. A method as defined in example 1, comprising the more specific step of applying the ESMR film to the support member with one side of the ESMR film being captured to the film contacting faces, with the film alternating between concave arcuate sections and convex arcuate sections, said film contacting faces mechanically isolating each arcuate section of the ESMR film from adjacent arcuate sections.

14. A method as defined in example 1, further comprising the step of preforming the ESMR film with the arcuate sections prior to applying the film to the support member.

15. A method as defined in example 1, further comprising the step of thermal forming the ESMR film into the arcuate sections.

16. A method as defined in example 1, further comprising the step of etching away at least one section of at least one surface side of an electrically conductive portion of the ESMR film, thereby forming at least two electrically isolated conductive portions of the film on at least one surface side of the film.

16a. A transducer as defined in example 13, further including being driven by signals of more than one phase, wherein at least two opposite phase signals are used to drive the electrically isolated conductive portions of the film.

17. The method of example 16, further comprising the step of driving the electrically isolated conductive portions of ESMR film by multiple parametric signals.

18. A method as defined in example 17, further comprising the step of phase delaying the multiple parametric signals, wherein at least one of the signals is delayed to establish a phase differential.

19. A method as defined in example 18, comprising the more specific step of etching away at least one ring section of the electrically conductive portion of the ESMR film, thereby forming at least a center circular conductive portion of the film, and at least one outer ring conductive portion of the film, wherein each of the conductive portions of the film is electrically isolated.

20. A method as defined in example 4, further comprising the step of applying an electrostatic charge on the backplate to stabilize the arcuate sections of the ESMR film.

21. A method as defined in example1, wherein the step of applying the ESMR film to the support member further comprises the step of using an adhesive material to capture the film to the film contacting faces.

22. A method as defined in example 21, wherein the adhesive material is a thermally conductive adhesive.

23. A method as defined in example 21, wherein the adhesive material is an electrically conductive adhesive.

24. A method as defined in example 21, further comprising the step of applying the adhesive material to the film contacting faces using a screen printing technique to ensure a uniform application.

25. A method as defined in example 21, further comprising the step of applying the adhesive material on the film contacting faces with a thickness of less than approximately ten thousandths of an inch.

26. A method as defined in example 1, further comprising the step of structuring the film contacting faces to include a convex curvature with respect to the front surface.

27. A method as defined in example 1, further comprising the step of coupling the ESMR film to edges of the support member using a C-channel conductive mechanism, providing a relatively large electrical coupling area between the C-channel and the ESMR film as compared to point contacts of electrical coupling.

28. A method as defined in example 1, further comprising the step of positioning adjacent central peak depths of the arcuate sections at a distance from one another of less than one-half wavelength of a carrier wave frequency to be propagated from the transducer.

29. A method as defined in example 1, comprising the more specific step of structuring the predetermined separation distances of the parallel ridges to include at least two different distances.

30. A method as defined in example 1, comprising the more specific step of structuring the arcuate sections of ESMR film to include at least two different radii.

31. A method as defined in example 1, comprising the additional step of configuring the support member to allow bidirectional propagation of emitted waves from the ESMR film, both in a forward direction and a rearward direction.

32. A method as defined in example 4, comprising the additional step of configuring the ESMR film to have at least one dimension of at least approximately ten wavelengths of a dominant or carrier wave frequency to be propagated from the transducer.

33. A method as defined in example 1, comprising the additional step of configuring the ESMR film to have at least one dimension of at least approximately five wavelengths of a dominant or carrier wave frequency to be propagated from the transducer.

34. A method as defined in example 1, comprising the additional step of configuring arc lengths of the arcuate sections to be defined by a central angle of no greater than approximately 100 degrees.

35. A method as defined in example 1, further comprising the step of configuring the support member and the ESMR film to have a concave dish curvature for focusing a propagated wave.

36. A method as defined in example 1, further comprising the step of configuring the support member and the ESMR film to have a convex dish curvature for dispersing a propagated wave.

37. A method for constructing a parametric transducer, comprising the steps of:
(a) preparing a support member having opposing front and back surfaces, wherein at least the front surface is in a smooth continuous configuration;
(b) forming an electrically sensitive and mechanically responsive (ESMR) film with an array of parallel arcuate emitter sections alternatively separated by parallel contacting faces, said ESMR film being configured for emitting parametric output; and
(c) capturing the parallel contacting faces of the ESMR film at the front surface of the support member, thereby mechanically isolating each of the arcuate sections of ESMR film from adjacent arcuate sections.

38. A method as defined in example 37, comprising the more specific step of establishing a radius of the convex arcuate sections such that at least central peak depths of the arcuate sections each have a separation distance from the front surface of the support member of no greater than approximately one-quarter wavelength of a carrier wave frequency to be propagated from the transducer.

39. A method as defined in example 37, comprising the more specific step of establishing a radius of the convex arcuate sections such that at least central peak depths of the arcuate sections each have a separation distance from the front surface of the support member of no greater than approximately one-half wavelength of a carrier wave frequency to be propagated from the transducer.

40. A method as defined in example 37, further comprising the step of configuring the support member such that the convex arcuate sections of ESMR film have opposing ends that are maintained open to airflow.

41. A method as defined in example 37, further comprising the step of configuring the support member such that the convex arcuate sections of ESMR film have at least one opposing end that is substantially blocked to airflow.

42. A method as defined in example 37, further comprising the step of preforming the ESMR film with the convex arcuate sections prior to applying the film to the support member.

43. A method as defined in example 37, further comprising the step of thermal forming the ESMR film into the arcuate sections.

44. A method as defined in example 37, further comprising the step of etching away at least one section of an electrically conductive portion of the ESMR film, thereby forming at least two electrically isolated conductive portions of the film.

45. The method of example 44, further comprising the step of driving the electrically isolated conductive portions of ESMR film by multiple parametric signals.

46. A method as defined in example 45, further comprising the step of phase delaying the multiple parametric signals, wherein at least one of the signals is delayed to establish a phase differential.

47. A method as defined in example 46, comprising the more specific step of etching away at least one ring section of the electrically conductive portion of the ESMR film, thereby forming at least a center circular conductive portion of the film, and at least one outer ring conductive portion of the film, wherein each of the conductive portions of the film is electrically isolated.

48. A method as defined in example 37, wherein the step of applying the ESMR film to the support member further comprises the step of using an adhesive material to capture the film to the film contacting faces.

49. A method as defined in example 48, wherein the adhesive material is a thermally conductive adhesive.

50. A method as defined in example 48, wherein the adhesive material is an electrically conductive adhesive.

51. A method as defined in example 48, further comprising the step of applying the adhesive material to the film contacting faces using a screen printing technique to ensure a uniform application.

52. A method as defined in example 48, further comprising the step of applying the adhesive material on the film contacting faces with a thickness of less than approximately ten thousandths of an inch.

53. A method as defined in example 37, further comprising the step of coupling the ESMR film to edges of the support member using a C-channel conductive mechanism, providing a relatively large electrical coupling area between the C-channel and the ESMR film as compared to point contacts of electrical coupling.

54. A method as defined in example 37, further comprising the step of positioning adjacent central peak depths of the convex arcuate sections at a distance from one another of less than one-half wavelength of a carrier wave frequency to be propagated from the transducer.

55. A method as defined in example 37, comprising the more specific step of structuring the convex arcuate sections of ESMR film to include at least two different radii.

56. A method as defined in example 37, comprising the additional step of configuring the ESMR film to have a width along the y-axis of at least approximately five wavelengths of a carrier wave frequency to be propagated from the transducer.

57. A method as defined in example 37, comprising the additional step of configuring arc lengths of the convex arcuate sections to be defined by a central angle of no greater than approximately 100 degrees.

58. A method as defined in example 37, further comprising the step of configuring the support member and the ESMR film to have a concave dish curvature for focusing a propagated wave.

59. A method as defined in example 37, further comprising the step of configuring the support member and the ESMR film to have a convex dish curvature for dispersing a propagated wave.

60. A method for constructing a parametric transducer, comprising the steps of:
(a) preparing a support member capable of capturing an integral, electrically sensitive and mechanically responsive (ESMR) film at spaced intervals such that the ESMR film has arcuate emitter sections configured to be mechanically isolated from each other; and
(b) applying the ESMR film to the support member, said ESMR film configured for emitting parametric output and with an array of parallel arcuate sections alternatively separated by parallel contacting faces, wherein the parallel contacting faces are captured to the support member, thereby mechanically isolating each of the arcuate sections of ESMR film from adjacent arcuate sections.

61. A method for preparing an electrically sensitive and mechanically responsive (ESMR) emitter film to be applied to a transducer, comprising the steps of:
(a) heating the ESMR film to a predefined temperature, thereby altering the dimensions of the film in at least one direction; and
(b) capturing the ESMR film to a support member while the film is in its heated state, thereby maintaining captured portions of the film at their altered dimensions when the film is subsequently cooled, and allowing free-moving portions of the film to return to approximately their original state when the film is subsequently cooled.

62. The method according to claim 61, further comprising the step of forming the ESMR film to a predetermined configuration while the film is in its heated state, prior to capturing the ESMR film to the support member.

63. The method according to claim 61, comprising the more specific step of heating the ESMR film to a predefined temperature, thereby expanding the dimensions of the film in at least one direction.

64. The method according to claim 61, comprising the more specific step of heating the ESMR film to a predefined temperature, thereby contracting the dimensions of the film in at least one direction. [Does the heated film expand or contract?]

65. The method according to claim 61, wherein the ESMR emitter film is to be applied to a parametric audio transducer.

66. The method according to claim 61, wherein the ESMR emitter film is to be applied to a conventional audio transducer.

67. The method according to claim 65, comprising the more specific step of heating the ESMR film to an approximate temperature reached by the ESMR film while it is being driven by a parametric ultrasonic signal.

68. The method according to claim 66, comprising the more specific step of heating the ESMR film to an approximate temperature reached by the ESMR film while it is being driven by an audio signal.

69. The method according to claim 61, comprising the more specific step of heating the ESMR film to approximately 50 degrees Celsius.

70. The method according to claim 61, further comprising the step of forming the support member to have an array of parallel ridges separated from one another in a spacing configuration corresponding to the captured portions of the film; said ridges having forward, film contacting faces to capture the ESMR film in a desired film configuration.

71. The method according to claim 61, further comprising the step of forming the support member having opposing front and back surfaces, wherein at least the front surface is in a smooth continuous configuration.

72. The method according to claim 61, wherein the preferred configuration of the ESMR film is comprised of an array of arcuate sections running parallel to each other, said arcuate sections separated from one another in spacing configuration corresponding to the captured portions of the film.,

73. The method according to claim 61, wherein forming of the ESMR film to the preferred shape includes the more specific steps of:
(a) providing a forming plate having an array of parallel, arcuate surfaces separated by ridges corresponding in spacing configuration to the captured portions of the film, and having a plurality of apertures providing for airflow through the forming plate at a front surface;
(b) placing the ESMR film onto the forming plate;
(c) heating the ESMR film to the predefined temperature; and
(d) drawing a vacuum at the front surface of the forming plate to preform the ESMR film with the arcuate sections.

74. The method according to claim 61, wherein capturing the formed ESMR film to the support member includes the more specific step of applying thin, uniform layers of adhesive to the support member in areas corresponding to the captured portions of the film.

75. A device for preforming an electrically sensitive and mechanically responsive (ESMR) film to be disposed over a support member of a transducer, comprising:
(a) a forming plate having opposing front and back surfaces, the forming plate having an array of parallel arcuate surfaces with respect to the front surface and an array of parallel ridges individually separating the respective arcuate surfaces; and
(b) a pressure source coupled to the forming plate for urging the film sequentially into the arcuate surfaces.

76. A device as defined in claim 75, further comprising a plurality of apertures providing for airflow through the forming plant at the front surface.

77. A device as defined in claim 75, further comprising a vacuum source attached to the apertures for creating negative pressure at the front surface.

78. A device as defined in claim 75, wherein the parallel arcuate surfaces are convex with respect to the front surface of the forming plate.

79. A device as defined in claim 75, wherein the parallel arcuate surfaces are concave with respect to the front surface of the forming plate.

80. A device as defined in claim 75, wherein the parallel arcuate surfaces alternate between concave and convex with respect to the front surface of the forming plate.

81. A device as defined in claim 75, wherein each of the parallel ridges are flat.

82. A device as defined in claim 78, wherein each of the parallel ridges are concave with respect to the front surface of the forming plate.

83. A device as defined in claim 79, wherein each of the parallel ridges are convex with respect to the front surface of the forming plate.

84. A method as defined in claim 73, comprising the more specific step of drawing the vacuum across the front surface of the forming plate in a sequential manner to serially preform the ESMR film with the arcuate sections

85. A method as defined in claim 1, further comprising preparing the support member by etching channels and conductive sections into a substrate in accordance printed circuit board etching procedures.
